(19) United States
(12) Patent Application Publication
(10) Pub. No.: US 2025/0392418 A1
(43) Pub. Date: Dec. 25, 2025

(54) APPARATUS AND METHODS FOR CHANNEL SOUNDING OF DISTRIBUTED RESOURCE UNITS (DRUS)

(71) Applicant: InterDigital Patent Holdings, Inc., Wilmington, DE (US)

(72) Inventors: Mahmoud Saad, Montreal (CA); Hanqing Lou, Syosset, NY (US); Xiaofei Wang, North Caldwell, NJ (US); Ying Wang, Easton, PA (US); Joseph Levy, Merrick, NY (US); Rui Yang, Greenlawn, NY (US)

(73) Assignee: InterDigital Patent Holdings, Inc., Wilmington, DE (US)

(21) Appl. No.: 18/750,665

(22) Filed: Jun. 21, 2024

(51) Int. Cl. H04L 5/00; H04W 24/10; H04W 84/12

(52) U.S. Cl. CPC H04L 5/0044; H04W 24/10; H04W 84/12

(57) ABSTRACT

Apparatus, methods and procedures of channel sounding are disclosed herein. In an example, an access point (AP) transmits, to a station (STA), a frame to solicit the transmission of a null data packet (NDP). The STA receives the frame. Further, the frame includes distributed resource unit (DRU) information indicating a DRU. The frame may be at least one of a control frame, management frame, or data frame. The STA transmits, to the AP, the NDP, which is received by the AP. Further, long training fields (LTFs) of the NDP are transmitted over a plurality of distributed tones of the DRU, and the DRU is indicated by the received DRU information. Accordingly, the channel sounding may be performed in a Wi-Fi system. In an example, the DRU information indicating the DRU may include a DRU allocation index field, or both a DRU allocation index field and a distribution bandwidth field.

### BACKGROUND

A wireless local area network (WLAN) in Infrastructure Basic Service Set (BSS) mode has an Access Point (AP) for the BSS and one or more stations (STAs) associated with the AP. The AP typically has access or interface to a Distribution System (DS) or another type of wired/wireless network that carries traffic in and out of the BSS. Traffic to STAs that originates from outside the BSS arrives through the AP and is delivered to the STAs. Traffic originating from STAs to destinations outside the BSS is sent to the AP to be delivered to the respective destinations. Traffic between STAs within the BSS may also be sent through the AP where the source STA sends traffic to the AP and the AP delivers the traffic to the destination STA.

The traffic between STAs within a BSS may be considered as or referred to as peer-to-peer traffic. The peer-to-peer traffic may be sent between, for example, directly between, the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP; and the STAs, for example, all of the STAs, within or using the IBSS may communicate directly with each other. The IBSS mode of communication may sometimes be referred to herein as an “ad-hoc” mode of communication.

Using the 802.11ac infrastructure mode of operation, the AP may transmit a beacon on a fixed channel, usually the primary channel. This channel may be 20 megahertz (MHz) wide and is the operating channel of the BSS. This channel is also used by the STAs to establish a connection with the AP. The fundamental channel access mechanism in an 802.11 system is Carrier Sense Multiple Access with Collision Avoidance (CSMA/CA). In this mode of operation, every STA, including the AP, will sense the primary channel. If the channel is detected to be busy, the STA backs off. Hence only one STA may transmit at any given time in a given BSS.

In 802.11n, High Throughput (HT) STAs may also use a 40 MHz wide channel for communication. This is achieved by combining the primary 20 MHz channel, with an adjacent 20 MHz channel to form a 40 MHz wide contiguous channel. In 802.11ac, Very High Throughput (VHT) STAs may support 20 MHZ, 40 MHZ, 80 MHZ, and 160 MHz wide channels.

### SUMMARY

Apparatus, methods and procedures of channel sounding are disclosed herein. In an example, an access point (AP) transmits, to a station (STA), a frame to solicit the transmission of a null data packet (NDP). The STA receives the frame. Further, the frame includes distributed resource unit (DRU) information indicating a DRU. Additionally or alternatively, the frame may be at least one of a control frame, management frame or data frame. Additionally or alternatively, the control frame may be a trigger frame. The STA transmits, to the AP, the NDP. Further, one or more long training fields (LTFs) of the NDP are transmitted over a plurality of distributed tones of the DRU. Moreover, the DRU is indicated by the received DRU information. The AP receives the NDP. Accordingly, the channel sounding may be performed in a Wi-Fi system.

Additionally or alternatively, the DRU information indicating the DRU may include a DRU allocation index field, or both a DRU allocation index field and a distribution bandwidth field. Additionally or alternatively, the distribution bandwidth field may include a distribution bandwidth field value and an allocated distribution bandwidth, and each value of the distribution bandwidth field value corresponds to a respective distribution bandwidth of the allocated distribution bandwidth.

Additionally or alternatively, the STA may receive, from the AP, channel state information (CSI) feedback responsive to the transmitted NDP. Additionally or alternatively, the STA may transmit, to the AP during an association, re-association or a probe request, a DRU sounding support indication within a capabilities information field.

Additionally or alternatively, the control frame may include an NDP announcement (NDPA) frame including a STA info field, the STA info field indicating a STA association identifier (AID) field, and indicating a DRU allocation index field, or both a DRU allocation index field and a distribution bandwidth field. Additionally or alternatively, the control frame includes a first STA info field for DRU sounding on a first subchannel based on a first DRU allocation index field and a first distribution bandwidth field, and the control frame further includes a second STA info field for regular resource unit (RRU) sounding on a second subchannel. Additionally or alternatively, the first and the second STA info fields may have different AIDs, and wherein the second STA info field is for another STA for DRU sounding on a second subchannel based on a second DRU allocation index field and a second distribution bandwidth field. Additionally or alternatively, the first and the second STA info fields may have a same AID.

Additionally or alternatively, the first subchannel is a primary subchannel. Additionally or alternatively, the second subchannel is a secondary subchannel non-overlapping with the first subchannel.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2A is a system diagram illustrating an example Wi-Fi system;

FIG. 2B is a system diagram illustrating an example of indicating a particular distributed resource unit (DRU);

FIG. 3 is a frame format diagram illustrating an example of a high efficiency (HE) null data packet announcement (NDPA) frame format;

FIG. 4 is a field format diagram illustrating an example of a station (STA) Info field format in an extremely high throughput (EHT) NDPA frame;

FIG. 5A is a frame format diagram illustrating an example of an HE variant Common Info field format in a trigger frame;

FIG. 5B is a frame format diagram illustrating an example of an EHT variant Common Info field format in a trigger frame;

FIG. 5C is a frame format diagram illustrating an example of a Special User Info field;

FIG. 6 is a frame format diagram illustrating an example of an HE variant User Info field format and an EHT variant User Info field format in a trigger frame;

FIG. 7 is a transmission diagram illustrating a general example of a DRU over a distribution bandwidth;

FIG. 8 is a transmission diagram illustrating an example of a general uplink sounding procedure for a DRU;

FIG. 9 is a transmission diagram illustrating an example of ultra high reliability (UHR) sounding null data packet (NDP) formats for DRUs;

FIG. 10 is a channel diagram illustrating an example of a hybrid channel sounding example;

FIG. 11 is a signaling procedure diagram illustrating an example of non-trigger-based DRU sounding;

FIG. 12 is a channel diagram illustrating an example for a punctured 80 megahertz (MHz) with two different distribution bandwidths, the first is 20 MHz and the second is 40 MHZ;

FIG. 13 is a channel diagram illustrating an example for a punctured 80 MHz with two different distribution bandwidths, the first is 40 MHz and the second is 20 MHZ;

FIG. 14 is a channel signaling diagram illustrating an example of channel sounding of a punctured DRU distributed over an 80 MHz distribution bandwidth with a 20 MHz puncture;

FIG. 15 is a signaling diagram illustrating an example of channeling sounding over distributed tones of a DRU; and

FIG. 16 is a flowchart diagram illustrating an example of behavior of STAs for uplink DRU channel sounding.

### DETAILED DESCRIPTION

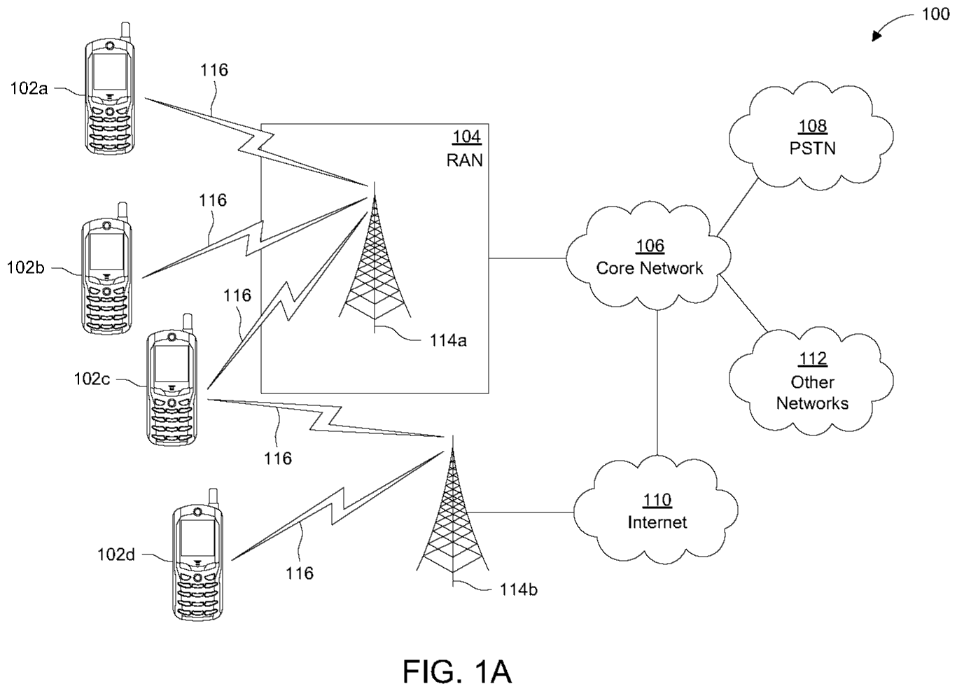

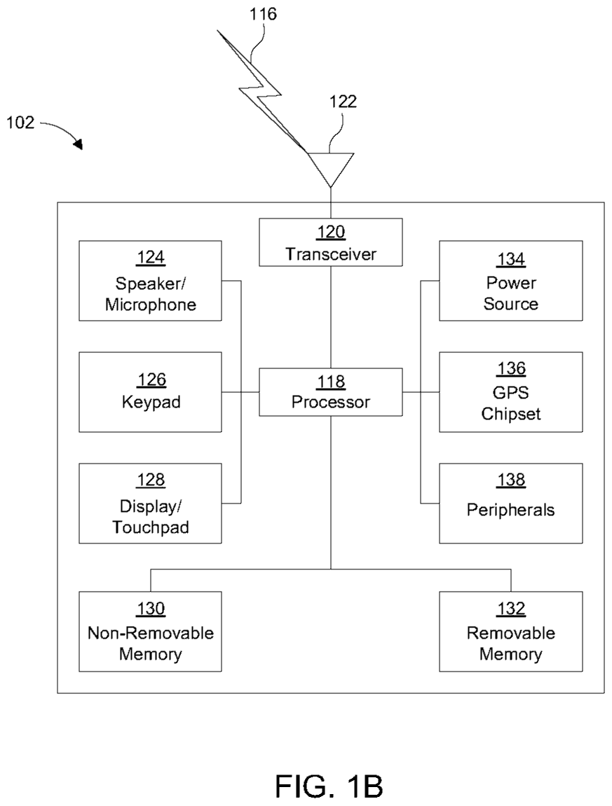

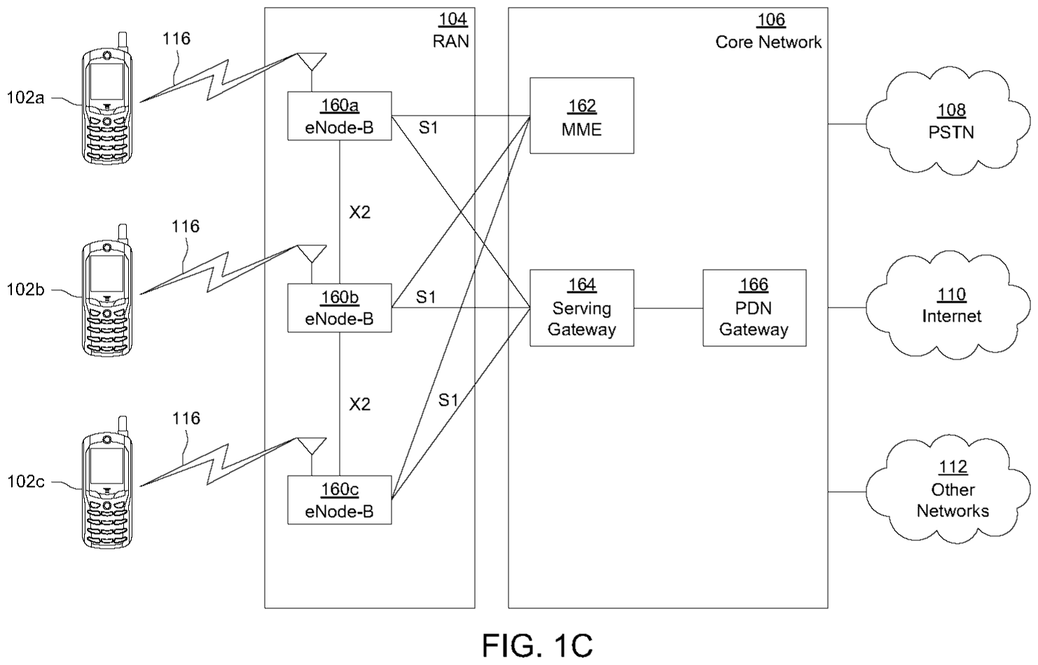

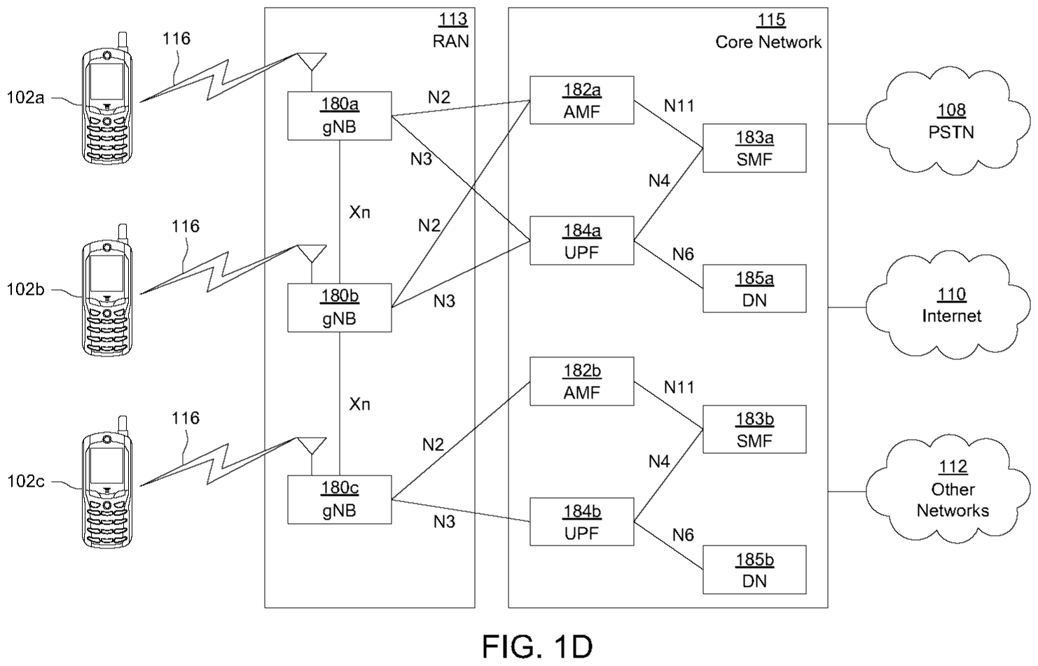

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discrete Fourier transform (DFT) Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (and/or a “STA”), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device (e.g., gaming devices), a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to, for example, facilitate access to one or more communication networks, such as the CN 106, the Internet 110, and/or the other networks 112. By way of example, the base stations 114a, 114b may be a base transceiver station (BTS), a Node B, an eNode-B (eNB), a Home Node-B (HNB), a Home eNode-B (HeNB, a next generation Node-B (NR NB), such as a gNode-B (gNB), a new radio (NR) Node-B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or Wi-Fi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, the gNBs 180a, 180b, 180c may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 182a, 182b may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

An AP may transmit a beacon on a fixed channel, such as a primary channel. The primary channel may be a fixed width, for example, 20 megahertz (MHZ) wide bandwidth, or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off for a certain period of time before sensing again. One STA (e.g., only one station) may transmit at any given space, time and frequency resource in a given BSS.

In other representative embodiments, an AP may assign bandwidth resources over which associated STAs communicate with the AP. Bandwidth resources may include one or more channels (i.e., contiguous, or non-contiguous), one or more subchannels within a channel, one or more resource units (RUs) within an Orthogonal Frequency division Multiple Access (OFDMA) system, whereby assigned one or more RUs may be adjacent (i.e., contiguous) or non-contiguous, occupying one or more channels or subchannels, etc.

High Throughput (HT or 802.11n) STAs may use a 40 MHz wide channel for communication, for example, via a combination of the primary 20 MHz channel with an adjacent or nonadjacent 20 MHz channel to form a 40 MHz wide channel.

Very High Throughput (VHT or 802.11ac) STAs may support 20 MHz, 40 MHZ, 80 MHZ, and/or 160 MHz wide channels transmitted over a 5 GHz frequency band using OFDMA. The 40 MHZ, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

High Efficiency Wireless (HEW or 802.11ax) STAs may support 20 MHz, 40 MHZ, 80 MHZ, and/or 160 MHZ wide channels capable of transmission over 2.4 GHZ, 5 GHZ, and 6 GHz frequency bands using both OFDMA and multi-user multiple-input multiple-output (MU-MIMO) capabilities. OFDMA subcarrier modulation in HE STAs includes formats such as BPSK, QPSK, 16-QAM, 64-QAM, 256-QAM, 1024-QAM. The evolution of 802.11 to Extremely High Throughput (EHT) STAs extends to having 320 MHz wide channels.

While earlier generation 802.11 STAs (e.g., HEW or 802.11ax) could decide to transmit on one of the 2.4, 5.0, or 6 GHz bands, EHT STAs are further capable of multi-link operation (MLO), whereby data transmission between an EHT AP and non-AP STAs can occur over multiple bands simultaneously (e.g., 5 GHZ and 6 GHZ) thus increasing throughput and/or reliability. EHT STAs also benefit from a jump in QAM modulation from 1024-QAM to 4K-QAM, while enabling peak data rates of around 46 Gbps compared to the 9.6 Gbps capabilities of HEW STAs.

The next generation of 802.11 standard, 802.11bn (i.e., Ultra High Reliability-UHR) explores the possibility to improve reliability, support further reduced low latency traffic, further increase peak throughput, improved power saving capabilities and improve efficiency of the IEEE 802.11 network over HEW. These improvements are driven by technological advancements such as 360 immersive video, ultra-high-resolution streaming, online gaming, remote surgery, rapid expansion of Internet of Things (IoT), etc. Other 802.11 standard development examples are directed to areas such as: the application and management of artificial intelligence and machine learning (AIML) in WLANs, expanding WiFi communications into the millimeter-wave frequency band (integrated millimeter-wave-IMMW), energy harvesting based on of WiFi RF signals for facilitating WLAN communications of low-power IoT devices, and the randomization of MAC addresses in WLANs.

As described above, in 802.11n, HT STAs may also use a 40 MHz wide channel for communication. This is achieved by combining the primary 20 MHz channel, with an adjacent 20 MHz channel to form a 40 MHz wide contiguous channel.

In 802.11ac, VHT STAs may support 20 MHz, 40 MHZ, 80 MHZ, and 160 MHz wide channels. The 40 MHZ, and 80 MHZ, channels are formed by combining contiguous 20 MHz channels similar to 802.11n described above. A160 MHz channel may be formed either by combining 8 contiguous 20 MHz channels, or by combining two non-contiguous 80 MHz channels, which may also be referred to as an 80+80 configuration. For the 80+80 configuration, the data, after channel encoding, is passed through a segment parser that divides it into two streams. The Inverse Discrete Fourier Transformation (IDFT) operation and time-domain processing is done on each stream separately. The streams are then mapped on to the two channels, and the data is transmitted. At the receiver, this mechanism is reversed, and the combined data is sent to the MAC.

Sub 1 GHz modes of operation are supported by 802.11af, and 802.11ah. For these specifications the channel operating bandwidths, and carriers, are reduced relative to those used in 802.11n, and 802.11ac. 802.11af supports 5 MHZ, 10 MHz and 20 MHz bandwidths in the TV White Space (TVWS) spectrum, and 802.11ah supports 1 MHz, 2 MHZ, 4 MHZ, 8 MHZ, and 16 MHz bandwidths using non-TVWS spectrum. A possible use case for 802.11ah is support for Meter Type Control (MTC) devices in a macro coverage area. MTC devices may have limited capabilities including only support for limited bandwidths, but also include a requirement for a very long battery life.

WLAN systems which support multiple channels, and channel widths, such as 802.11n, 802.11ac, 802.11af, and 802.11ah, include a channel which is designated as the primary channel. The primary channel may, but not necessarily, have a bandwidth equal to the largest common operating bandwidth supported by all STAs in the BSS. The bandwidth of the primary channel is therefore limited by the STA, of all STAs in operating in a BSS, which supports the smallest bandwidth operating mode. In the example of 802.11ah, the primary channel may be 1 MHz wide if there are STAs (e.g. MTC type devices) that only support a 1 MHz mode even if the AP, and other STAs in the BSS, may support a 2 MHZ, 4 MHZ, 8 MHZ, 16 MHZ, or other channel bandwidth operating modes. All carrier sensing, and NAV settings, depend on the status of the primary channel; i.e., if the primary channel is busy, for example, due to a STA supporting only a 1 MHz operating mode is transmitting to the AP, then the entire available frequency bands are considered busy even though majority of it stays idle and available.

In the United States, the available frequency bands which may be used by 802.11ah are from 902 MHz to 928 MHz. In Korea it is from 917.5 MHz to 923.5 MHz; and in Japan, it is from 916.5 MHz to 927.5 MHz. The total bandwidth available for 802.11ah is 6 MHz to 26 MHz depending on the country code.

The IEEE 802.11 Ultra High Reliability (UHR) Study Group was formed explore the possibility to improve reliability, support low latency traffic and further increase peak throughput and improve efficiency of the IEEE 802.11 networks. A distributed-tone resource unit (DRU) may be used in UHR communications.

Further, 802.11bn may use DRU transmission and support DRU for a trigger based (TB) physical layer (PHY) PDU (TB-PPDU) transmission where the DRU means an RU which consists of subcarriers spreading across a certain bandwidth. A DRU is allowed in a punctured UHR TB transmission. Also, 802.11bn may use a hierarchical pilot structure for DRU such that the pilot locations of a larger DRU is a subset of the superset of the pilot locations of smaller component DRUs within the same PPDU bandwidth (BW). The number of pilot tones for the same size DRU and regular RU (RRU) is the same where the RRU means the existing RU defined in 11ax and 11be. Moreover, 802.11bn may use a hybrid mode with DRUs and RRUs in UHR UL TB OFDMA transmissions where the minimum PPDU BW for hybrid mode may be determined.

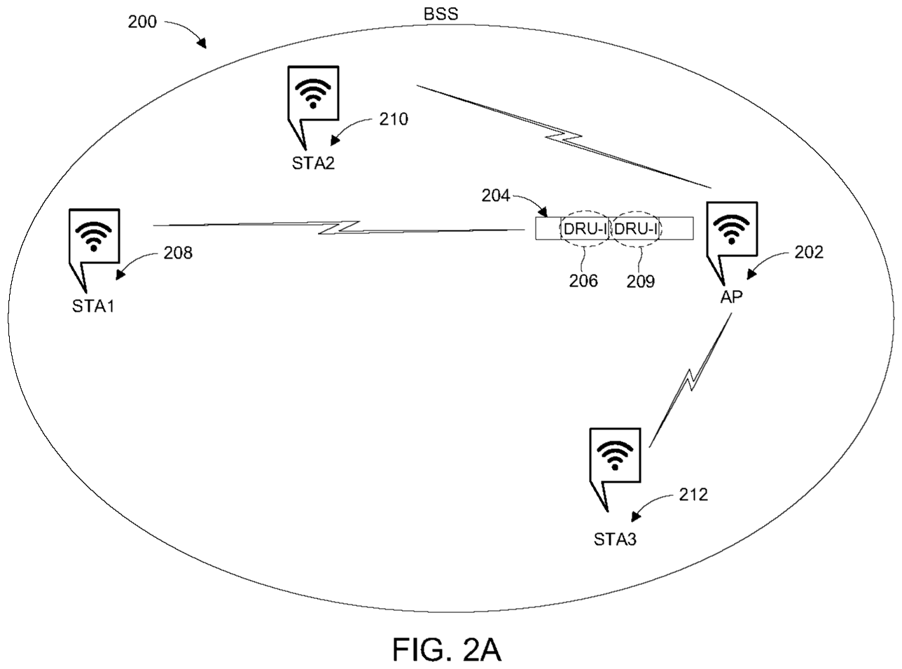

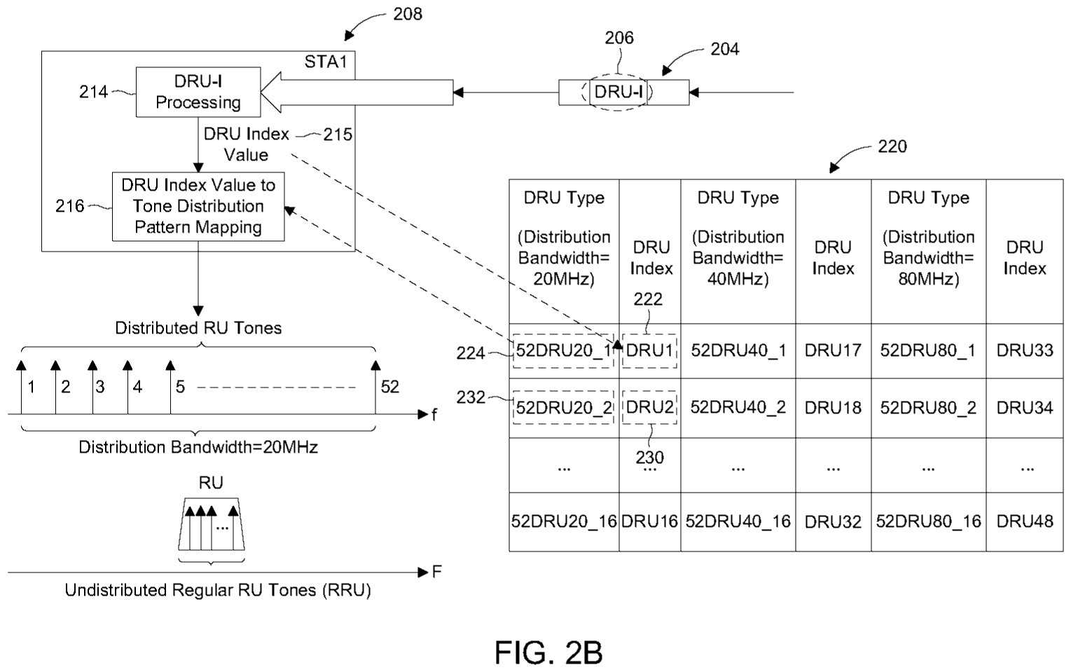

FIG. 2A is a system diagram illustrating an example Wi-Fi system. Examples shown in FIG. 2A include a Wi-Fi system, such as BSS 200, operable according to embodiments provided herein. In examples provided herein, channel sounding procedures are utilized to, among other things, determine channel state information (CSI) between an AP 202 and the STA1 208, STA2 210, STA3 212 of the BSS 200. In some instances, it may be appropriate for a STA to use distributed-tone resource units (DRUs) in channel sounding procedures when, for example, the distance between the STA and AP is beyond a certain range, thus warranting extended range transmissions. Additionally or alternatively, one or more of STAs 208, 210, 212 may be the same as or similar to WTRU 102. Additionally or alternatively, AP 202 may be the same as or similar to base station 114a, base station 114b, or both.

In an example, STA1 208 may communicate its ability to perform DRU sounding to the AP 202 by exchanging information indicating DRU sounding support during association, re-association or Probe request. In general, the AP 202 will already have knowledge of a STA's ability to perform DRU channel sounding as well as RRU channel sounding. Accordingly, the AP 202 may send a frame 204 including DRU information 206 to STA1 208. In examples, the frame 204 may be one or more of a management frame, control frame, or data frame. Additionally or alternatively, the control frame may be a trigger frame. The DRU information includes, for example, a DRU allocation index field, or both a DRU allocation index field and a distribution bandwidth field. Upon receiving the DRU information 206, the STA1 208 can indicate a particular DRU for the channel sounding procedure.

FIG. 2B is a system diagram illustrating an example of indicating a particular DRU. As shown in an example in FIG. 2B, STA1 208 receives a frame 204, including DRU information 206. Further, STA1 208 processes the received DRU information 206 at a DRU-I processing component 214 in order to extract either a DRU allocation index field, or both a DRU allocation index field and a distribution bandwidth field from the frame 204. In the illustrated example, a DRU index value 215 is obtained from the DRU allocation index field and sent to a mapping table 216 to indicate the particular DRU. For example, a mapping table such as table 220 may be incorporated within a DRU index to tone-distribution mapping component 216 to indicate a DRU by mapping a DRU index value to a DRU. For instance, based on obtaining a DRU index value of DRU1 222, table 220 can map the value DRU1 to a corresponding DRU such as 52DRU20_1 224, whereby 52DRU20_1 includes 52 subcarrier tones to be distributed over a 20 MHz bandwidth with tone distribution pattern 1. Additionally or alternatively, a mapping table may utilize both a distribution bandwidth value and a DRU index value to indicate a particular DRU.

Referring back to FIG. 2A, the AP 202 may also transmit frame 204 to STA2 210. Further, the AP's 202 transmitted frame 204 may also include DRU information 209 corresponding to STA2 210. Upon receiving the DRU information 209, the STA2 210 can also indicate a particular DRU for its channel sounding procedure. As depicted in FIG. 2B, for instance, based on obtaining a DRU index value of DRU2 230, table 220 can map the value DRU2 to a corresponding DRU such as 52DRU20_2 232, whereby 52DRU20_2 includes 52 subcarrier tones to be distributed over a 20 MHz bandwidth with tone distribution pattern 2. Further, tones of tone distribution pattern 2 may be interleaved in the frequency domain with tones of tone distribution pattern 1 for STA1. Additionally or alternatively, a mapping table may utilize both a distribution bandwidth value and a DRU index value to indicate a particular DRU.

In contrast, based on receiving frame 204, STA 3 212 may be assigned, by AP 202, with an RRU as opposed to a DRU for its channel sounding. However, it may also be contemplated that frame 204 may assign a hybrid channel sounding operation to any single STA capable of both operations. For example, based on receiving frame 204, STA3 212 may receive both DRU information for channel sounding over a first subchannel and an RRU for channel sounding over another second subchannel.

An EHT transmission has a preamble that contains EHT-long training field (LTF) symbols, where the data tones of each EHT-LTF symbol are multiplied by entries belonging to a matrix PEHT-LTF, to enable channel estimation at the receiver. The EHT-LTF field in the EHT preamble provides a means for the receiver to estimate the MIMO channel between the set of constellation mapper outputs and the receive chains.

In an EHT MU PPDU, N_{EHT-LTF} is indicated in the EHT-SIG field. In a non-OFDMA EHT MU PPDU or EHT sounding null data packet (NDP), the initial number of EHT-LTF symbols, initial N_{EHT-LTF}, is a function of the total number of spatial streams. In an EHT TB PPDU, N_{EHT-LTF} is indicated in the Trigger frame that triggers the transmission of the PPDU.

An EHT PPDU supports three EHT-LTF types: 1×EHT-LTF with a duration of 3.2 μs, 2×EHT-LTF with a duration of 6.4 μs, and 4×EHT-LTF with a duration of 12.8 μs.

In a 20 MHz transmission, the 1×HE-LTF sequence transmitted on subcarriers [−122:122] is given by: EHTLTF_{-122,122}={0, 0, −1, 0, 0, 0, +1, 0, 0, 0, +1, 0, 0, 0, −1, 0, 0, 0, +1, 0, 0, 0, −1, 0, 0, 0, +1, 0, 0, 0, +1, 0, 0, 0, +1, 0, 0, 0, +1, 0, 0, 0, −1, 0, 0, 0, −1, 0, 0, 0, +1, 0, 0, 0, +1, 0, 0, 0, +1, 0, 0, 0, −1, 0, 0, 0, −1, 0, 0, 0, −1, 0, 0, 0, +1, 0, 0, 0, −1, 0, 0, 0, −1, 0, 0, 0, +1, 0, 0, 0, +1, 0, 0, 0, −1, 0, 0, 0, −1, 0, 0, 0, +1, 0, 0, 0, −1, 0, 0, 0, −1, 0, 0, 0, +1, 0, 0, 0, −1, 0, 0, 0, 0, 0, 0, 0, −1, 0, 0, 0, +1, 0, 0, 0, +1, 0, 0, 0, +1, 0, 0, 0, +1, 0, 0, 0, +1, 0, 0, 0, +1, 0, 0, 0, −1, 0, 0, 0, −1, 0, 0, 0, −1, 0, 0, 0, 1, 0, 0, 0, −1, 0, 0, 0, +1, 0, 0, 0, −1, 0, 0, 0, −1, 0, 0, 0, −1, 0, 0, 0, +1, 0, 0, 0, −1, 0, 0, 0, −1, 0, 0, 0, +1, 0, 0, 0, −1, 0, 0, 0, −1, 0, 0, 0, +1, 0, 0, 0, −1, 0, 0, 0, +1, 0, 0, 0, −1, 0, 0, 0, −1, 0, 0, 0, −1, 0, 0, 0, −1, 0, 0, 0, −1, 0, 0}.

In a 20 MHz transmission, the 2×HE-LTF sequence transmitted on subcarriers [−122:122] is given by: EHTLTF_{-122,122}⁼{−1, 0, −1, 0, −1, 0, +1, 0, +1, 0, −1, 0, +1, 0, −1, 0, −1, 0, −1, 0, −1, 0, +1, 0, −1, 0, +1, 0, −1, 0, −1, 0, +1, 0, +1, 0, −1, 0, +1, 0, +1, 0, +1, 0, +1, 0, +1, 0, −1, 0, +1, 0, −1, 0, +1, 0, −1, 0, −1, 0, +1, 0, +1, 0, −1, 0, +1, 0, −1, 0, −1, 0, −1, 0, −1, 0, +1, 0, −1, 0, +1, 0, +1, 0, +1, 0, −1, 0, −1, 0, +1, 0, −1, 0, −1, 0, −1, 0, −1, 0, −1, 0, +1, 0, −1, 0, −1, 0, −1, 0, +1, 0, +1, 0, +1, 0, −1, 0, −1, 0, +1, 0, 0, 0, +1, 0, −1, 0, +1, 0, +1, 0, −1, 0, +1, 0, +1, 0, −1, 0, +1, 0, +1, 0, −1, 0, −1, 0, +1, 0, −1, 0, +1, 0, +1, 0, +1, 0, +1, 0, −1, 0, +1, 0, −1, 0, +1, 0, +1, 0, −1, 0, −1, 0, +1, 0, −1, 0, −1, 0, −1, 0, −1, 0, −1, 0, +1, 0, −1, 0, +1, 0, +1, 0, 1, 0, −1, 0, +1, 0, +1, 0, −1, 0, +1, 0, −1, 0, −1, 0, −1, 0, −1, 0, +1, 0, −1, 0, +1, 0, +1, 0, +1, 0, −1, 0, −1, 0, +1, 0, −1, 0, −1, 0, −1, 0, −1, 0, −1, 0, +1, 0, −1, 0, +1}.

In a 20 MHz transmission, the 4×HE-LTF sequence transmitted on subcarriers [−122:122] is given by:

$${EHTLTF}_{- 122 , 122} = \{ - 1 , - 1 , + 1 , - 1 , + 1 , - 1 , + 1 , + 1 , + 1 , - 1 , + 1 , + 1 , + 1 , - 1 , - 1 , + 1 , - 1 , - 1 , - 1 , - 1 , - 1 , + 1 , + 1 , - 1 , - 1 , - 1 , - 1 , + 1 , + 1 , - 1 , + 1 , - 1 , + 1 , + 1 , + 1 , + 1 , - 1 , + 1 , - 1 , - 1 , + 1 , + 1 , - 1 , + 1 , + 1 , + 1 , + 1 , - 1 , - 1 , + 1 , - 1 , - 1 , - 1 , + 1 , + 1 , + 1 , + 1 , - 1 , + 1 , + 1 , - 1 , - 1 , - 1 , - 1 , + 1 , - 1 , - 1 , + 1 , + 1 , - 1 , + 1 , - 1 , - 1 , - 1 , - 1 , + 1 , - 1 , + 1 , - 1 , - 1 , - 1 , - 1 , - 1 , - 1 , + 1 , + 1 , - 1 , - 1 , - 1 , - 1 , - 1 , + 1 , - 1 , - 1 , + 1 , + 1 , + 1 , - 1 , + 1 , + 1 , + 1 , - 1 , + 1 , - 1 , + 1 , - 1 , - 1 , - 1 , - 1 , - 1 , + 1 , + 1 , + 1 , - 1 , - 1 , - 1 , + 1 , - 1 , + 1 , + 1 , + 1 , 0 , 0 , 0 , - 1 , + 1 , - 1 , + 1 , - 1 , + 1 , + 1 , - 1 , + 1 , + 1 , + 1 , - 1 , - 1 , + 1 , - 1 , - 1 , + 1 , - 1 , + 1 , - 1 , + 1 , + 1 , + 1 , - 1 , + 1 , + 1 , + 1 , - 1 , - 1 , + 1 , - 1 , - 1 , - 1 , - 1 , - 1 , + 1 , + 1 , - 1 , - 1 , - 1 , - 1 , - 1 , - 1 , + 1 , - 1 , + 1 , - 1 , - 1 , - 1 , - 1 , + 1 , - 1 , + 1 , + 1 , - 1 , - 1 , + 1 , - 1 , - 1 , - 1 , - 1 , + 1 , + 1 , - 1 , + 1 , + 1 , + 1 , + 1 , + 1 , + 1 , + 1 , - 1 , + 1 , + 1 , - 1 , - 1 , - 1 , - 1 , + 1 , - 1 , - 1 , + 1 , + 1 , - 1 , + 1 , - 1 , - 1 , - 1 , - 1 , + 1 , - 1 , + 1 , - 1 , - 1 , + 1 , + 1 , + 1 , + 1 , - 1 , - 1 , + 1 , + 1 , + 1 , + 1 , + 1 , - 1 , + 1 , + 1 , - 1 , - 1 , - 1 , + 1 , - 1 , - 1 , - 1 , + 1 , - 1 , + 1 , - 1 , + 1 , + 1 \}$$

Wi-Fi communication may use an NDP announcement (NDPA). For example, in 802.11be communication, the structure of the NDPA may be similar to the NDPA of 802.11ax.

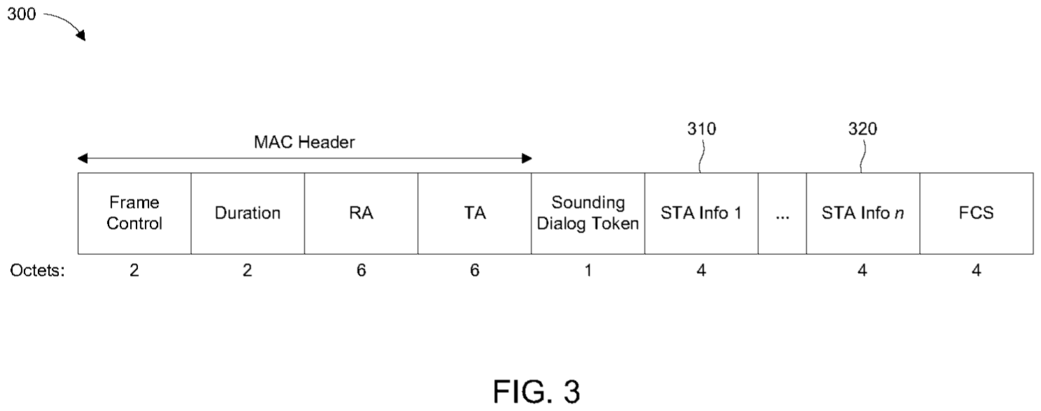

FIG. 3 is a frame format diagram illustrating an example of a high efficiency (HE) NDPA frame format. As shown in frame format diagram 300, the NDPA frame format may include a STA Info 1 field 310 for a first STA, as well as other STA Info fields, up to and including a STA Info n field 320. The other STA Info fields may be for the first STA, in an example. Additionally or alternatively, the other STA Info fields may be for other STAs. For example, a STA Info 2 field, not shown, may be for a second STA. Further, the STA Info n field 320 may be for an n^{th} STA. Example contents of a STA Info field are shown below.

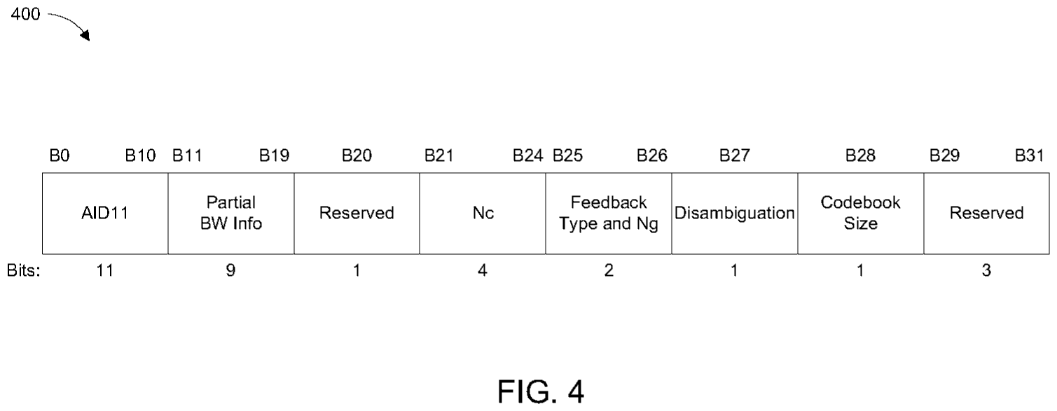

FIG. 4 is a field format diagram illustrating an example of a STA Info field format in an EHT NDPA frame. As shown in field format 400, the STA Info field format may include information for a STA. Additionally or alternatively, the STA Info field format may be changed to accommodate new features of UHR communication.

Tigger frame was introduced firstly in 802.11ax. EHT supports greater BW, multiple RU allocation, an enhanced modulation and coding scheme (MCS), and a greater number of spatial streams. 802.11be modified the trigger frame so that the trigger frame supports new features of 802.11be, and meanwhile the Trigger frame is backwards compatible with 802.11ax. The trigger frame is used to allocate resources, and trigger single user access or multi-user access. A trigger frame format defined in 802.11ax is shown in Table 1, below. 802.11be reuses the same format for the trigger frame.

TABLE 1
Trigger frame format in 802.11ax

| | Frame | | | | Common | User | | User | | |
|---|---|---|---|---|---|---|---|---|---|---|
| Field: | Control | Duration | RA | TA | Info | Info | . . . | Info | Padding | FCS |
| Octets: | 2 | 2 | 6 | 6 | 8 or | 5 or | | 5 or | v | 4 |
| | | | | | more | more | | more | | |

The Common Info field in 802.11be has two variants, the HE variant and the EHT variant.

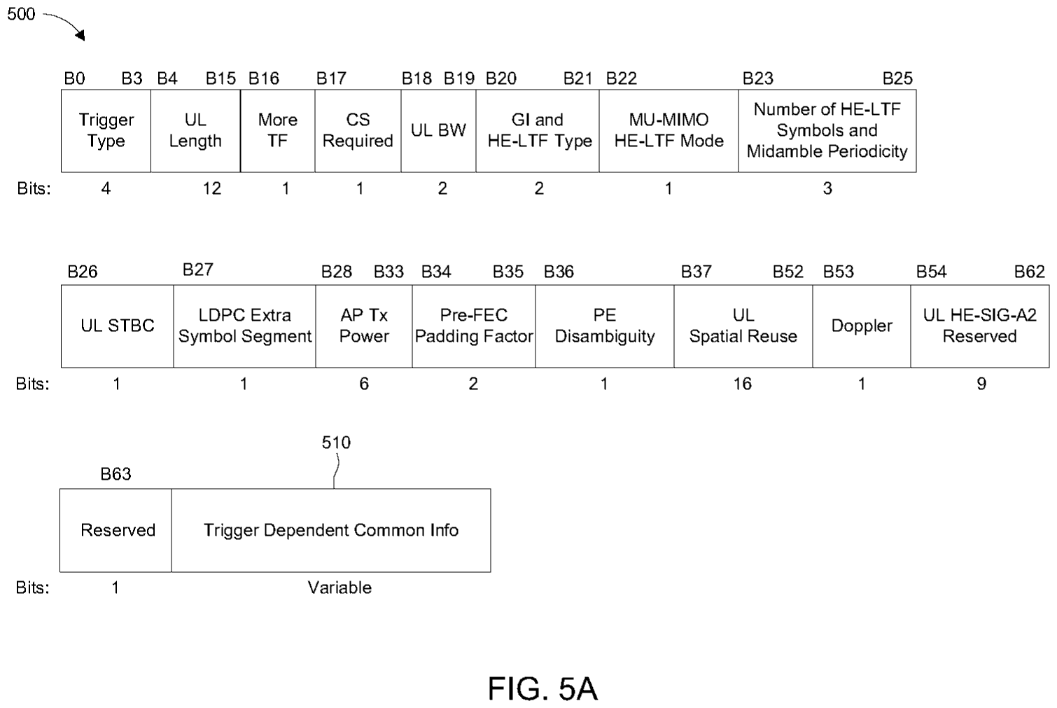

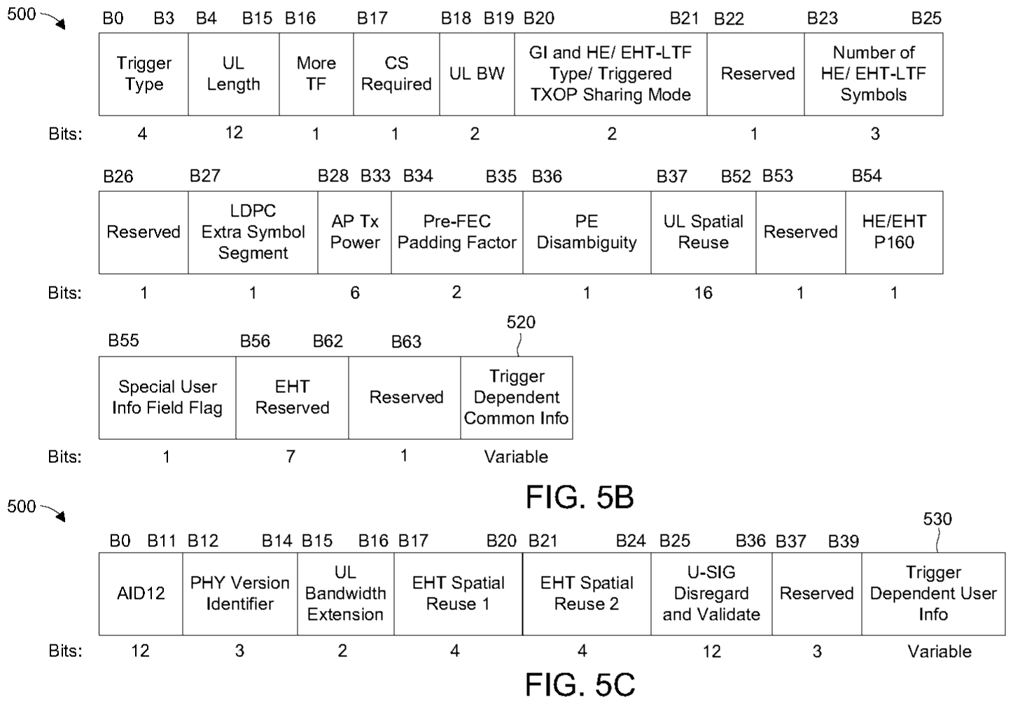

FIG. 5A is a frame format diagram illustrating an example of an HE variant Common Info field format in a trigger frame. As shown in an example in FIG. 5A, the Trigger Dependent Common Info subfield 510 may be of variable bit length. The bit lengths of the other subfields in the HE variant Common Info field format may be as shown in FIG. 5A.

FIG. 5B is a frame format diagram illustrating an example of an EHT variant Common Info field format in a trigger frame. As shown in an example in FIG. 5B, the Trigger Dependent Common Info subfield 520 may be of variable bit length. The bit lengths of the other subfields in the EHT variant Common Info field format may be as shown in FIG. 5B.

Further, there are three types of User Info fields defined in 802.11be: the Special User Info field, the HE variant User Info field and the EHT variant User Info field. The Special User Info field carries extended common information for EHT STAs to transmit a EHT TB-PPDU.

FIG. 5C is a frame format diagram illustrating an example of a Special User Info field. As shown in an example in FIG. 5C, the Trigger Dependent User Info subfield 530 may be of variable bit length. The bit lengths of the other subfields in the Special User Info field may be as shown in FIG. 5C.

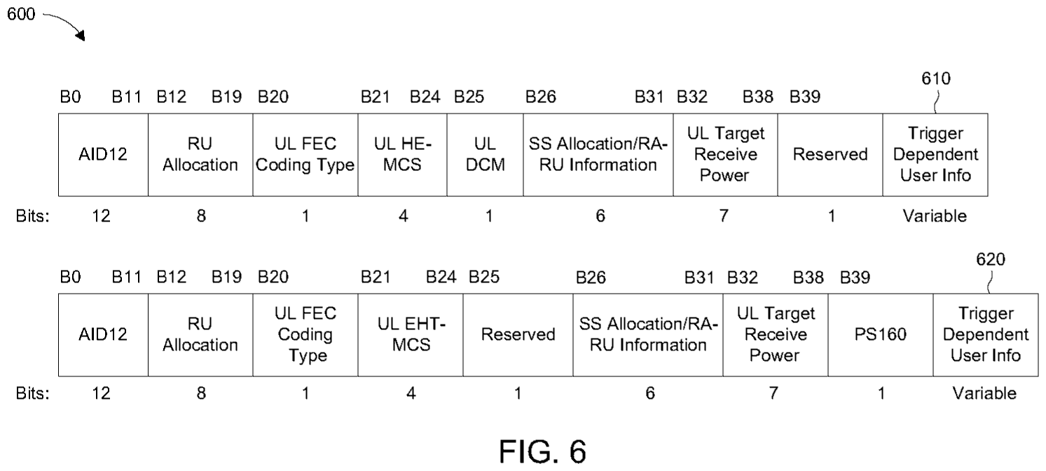

FIG. 6 is a frame format diagram illustrating an example of an HE variant User Info field format and an EHT variant Common Info field format in a trigger frame. The HE variant User Info field for all trigger types except Null Feedback Report Poll (NFRP) trigger is defined in the top part of FIG. 6. As shown in an example in FIG. 6, the Trigger Dependent User Info subfield 610 of the HE variant User Info field format may be of variable length. The bit lengths of the other subfields in the HE variant User Info field format may be as shown in FIG. 6.

Also, the EHT variant User Info field for all trigger types except NFRP trigger is defined in the bottom part of FIG. 6. As shown in an example in FIG. 6, the Trigger Dependent User Info subfield 620 of the EHT variant User Info field format may be of variable length. The bit lengths of the other subfields in the EHT variant User Info field format may be as shown in FIG. 6.

The trigger type subfield in Common Info field (such as in FIG. 5A or FIG. 5B), in the trigger frame format shown in Table 1, has possible values as shown in Table 2, below.

TABLE 2
Trigger Type

| Trigger | |
|---|---|
| Type | Trigger |
| Subfield | frame |
| value | variant |
| 0 | Basic |
| 1 | BF Report Poll (BFRP) |
| 2 | MU-BAR |
| 3 | MU-RTS |
| 4 | Buffer Status Report |
| | Poll (BSRP) |
| 5 | GCR MU-BAR |
| 6 | Bandwidth Query |
| | Report Poll (BQRP) |
| 7 | NDP Feedback Report |
| | Poll (NFRP) |
| 8 | Ranging/Sensing |
| 9-15 | Reserved |

In embodiments and examples provided herein, an RU may refer to one or more subcarriers used in DL and UL transmissions. Also, a tone may refer to one subcarrier used in DL or UL transmission. A DRU is a resource unit whose subcarriers are spread over a certain bandwidth which is larger than the effective bandwidth occupied by this resource unit. The effective bandwidth of an RU equals N×Δfₛ where N is the number of tones of the RU and Δfₛ is the subcarrier spacing. In WLAN, range extension can be achieved by distributing the tones of an RU over a wider bandwidth which allows for higher transmit power for each individual tone while at the same time conforming with the power spectral density (PSD) regulations. Further, a DRU may also be referred to as a tone distributed (TD) RU (TD-RU) or a distributed RU, and still be consistent with the embodiments and example provided herein.

Also, a distribution bandwidth may refer to a bandwidth in which the tones of a set of one or more DRUs are spread on. An RRU may refer to a resource unit whose subcarriers are contiguous as defined by 11ax and 11be amendments. In addition, a punctured channel may refer to a channel that has one or more of its subchannels punctured. Further, a punctured subchannel may refer to a subchannel that is left unused by any PPDU that is transmitted within the operating channel of the AP to a member of the BSS. Moreover, a puncturing pattern may refer to a specific set of subchannels that are punctured in the operating channel. As used herein in embodiments and examples herein, an associated STA identifier (AID) may refer to an associated identifier (AID), and these terms may be used interchangeably.

Further, a hybrid NDP may refer to a sounding NDP in which a part of the NDP is sent over the subcarriers of one or more DRUs and a different part is sent over the subcarriers of one or more RRUs, in embodiments and examples provided herein. Additionally, in embodiments and examples provided herein, hybrid uplink sounding may refer to a mode of channel sounding in which some beamformers are requested to send the sounding NDP over RRUs and some beamformers are requested to send the sounding NDP over DRUs. The same beamformer may send a hybrid NDP, where a part of the NDP is sent on the tones of a DRU and a separate part is sent on the tones of an RRU. The beamformee then send the feedback to the beamformers according to which part of the sounding NDP is requested in the channel sounding. In an example, a beamformee may receive, from a beamformer, one or more beams formed by the beamformer using the CSI feedback received in the channel sounding procedure.

Moreover, in embodiments and examples provided herein, hybrid downlink sounding may refer to a mode of channel sounding in which some STAs are requested to report the CSI feedback for the sounding NDP which is sent over RRUs and some STAs are requested to report the CSI feedback for the sounding NDP which is sent over DRUs.

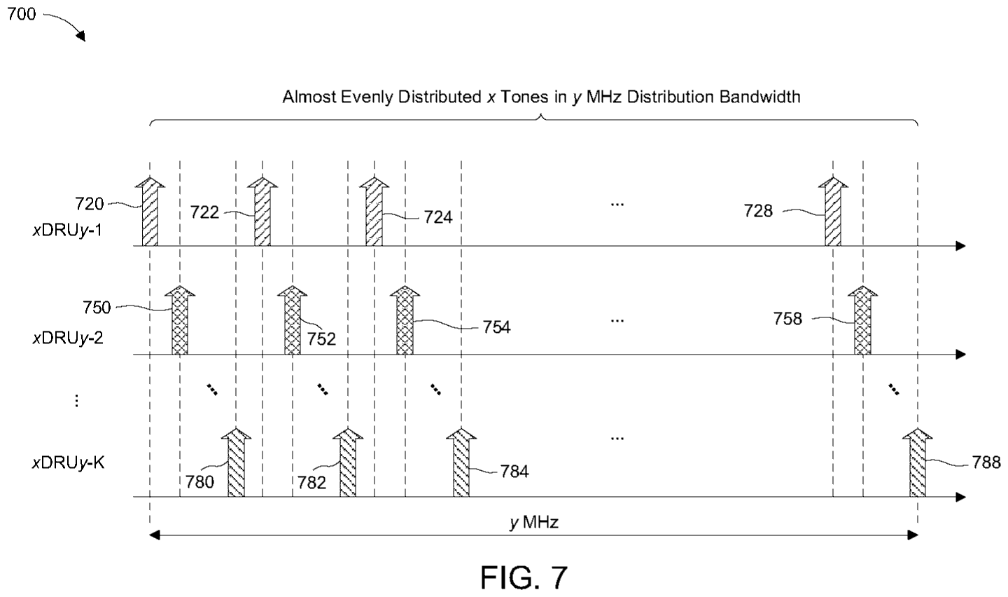

FIG. 7 is a transmission diagram illustrating a general example of a distributed-tone resource unit over a distribution bandwidth. As shown in an example in transmission diagram 700, a general x-tones DRU may be distributed over a y MHz distribution bandwidth, and may be denoted as xDRUy. In an example, a 26DRU20 is a 26-tone resource unit (effective bandwidth is ˜2 MHZ) with a DRU allocation spread over a distribution bandwidth of 20 MHz. In another example, a 106DRU80 is a 106-tone resource unit (effective bandwidth is ˜8 MHZ) with a DRU allocation spread over a distribution bandwidth of 80 MHz. A 20 MHz channel may include up to nine 26DRU20 DRU allocations, four 52DRU20 DRU allocations, or two 106DRU20 DRU allocations. For proper transmission, a channel bandwidth should accommodate the effective bandwidth of the DRUs as well as bandwidth needed for guard, null and DC subcarriers.

In an example shown in FIG. 7 for resource allocations for an xDRUy, a first DRU allocation for a first DRU type, such as xDRUy-1 may include a tone plan with tone distributed across subcarriers over a y MHz distribution bandwidth. For example, the tone plan for xDRUy-1 may include the transmission of tones 720, 722, 724, 728 over a first set of distributed subcarriers. The second DRU allocation for a second DRU type may include a tone plan for xDRUy-2. The tone plan for DRU allocation xDRUy-2 may transmit over a second set of distributed subcarriers adjacent to, but not overlapping with, the first set of distributed subcarriers. For example, the tone plan for DRU allocation xDRUy-2 may include the transmission of tones 750, 752, 754, 758 over the second set of distributed subcarriers. In order to ensure that the tones in tone plan for DRU allocation xDRUy-1 do not overlap with the tones in the tone plan for DRU allocation xDRUy-2, the spacing between the tones of the tone plan for DRU allocation xDRUy-1 will match the spacing between the tones of the tone plan for DRU allocation xDRUy-2, as shown in FIG. 7.

Further tone plans for the remaining DRU allocations for the remaining DRU types may include transmissions of tones over distributed subcarriers that do not overlap with the distributed subcarriers of the other tone plans. Similarly, the spacing between the tones within each of the tone plans will match for all DRU allocations for the DRU types of xDRUy, in order to ensure that the tones of one tone plan do not overlap with the tones of another. Moreover, the final DRU type, xDRUy-K will have a DRU allocation for its DRU type, including a tone plan with transmission of tones 780, 782, 784, 788 over another set of distributed subcarriers. In this way, the DRU allocations for the DRU types of xDRUy include almost evenly distributed x tones in the y MHz distribution bandwidth.

Embodiments and examples provided herein include channel sounding using one or more DRUs. For example, uplink channel sounding of a DRU enables uplink beamforming on the DRU. How the uplink channel sounding of the DRU will be performed is included in embodiments and examples provided herein. Examples provided herein include how the sounding NDP is transmitted by the non-AP STAs and how the feedback in uplink channel sounding of the DRU will be sent to the non-AP STAs.

Further, examples provided herein include downlink channel sounding, which can be performed in an efficient way which may save energy and improve the bandwidth efficiency.

Moreover, the distribution bandwidth of DRUs will be a contiguous part of the channel without puncturing in examples provided herein. For instance, an 80 MHz channel with one 20 MHz puncture will have two distribution bandwidths (20+40) or three distribution bandwidths (20+20+20). The channel sounding of the DRUs in the distribution bandwidths of a punctured channel is included in examples provided herein.

Examples provided herein include procedures for uplink channel sounding of DRUs. In an example, the channel sounding of DRUs in the uplink may be initiated by the beamformee by soliciting the transmission of a DRU null data packet (NDP) that uses the tone plan of a certain DRU from the beamformers. In example, the beamformee is an AP and the beamformers are non-AP STAs. By soliciting the NDP transmission, the non-AP STA may send the UHR-LTFs of the NDP using the subcarriers corresponding to the indicated DRU for this non-AP STA. The AP may solicit the transmission of the NDP using one or more of a control frame, a management frame, a data frame or any other frame that may be used to solicit response from the non-AP STA. This frame may contain one or more fields, where each field is identified by a STA ID, and each field contains information necessary for the non-AP STA to construct and transmit the NDP.

Additionally or alternatively, the above example may be applied where the beamformee is a non-AP STA and the beamformers are APs. In that case, the roles of the non-AP STA and APs in the example provided above are reversed, but the procedure is otherwise consistent with those provided in the example.

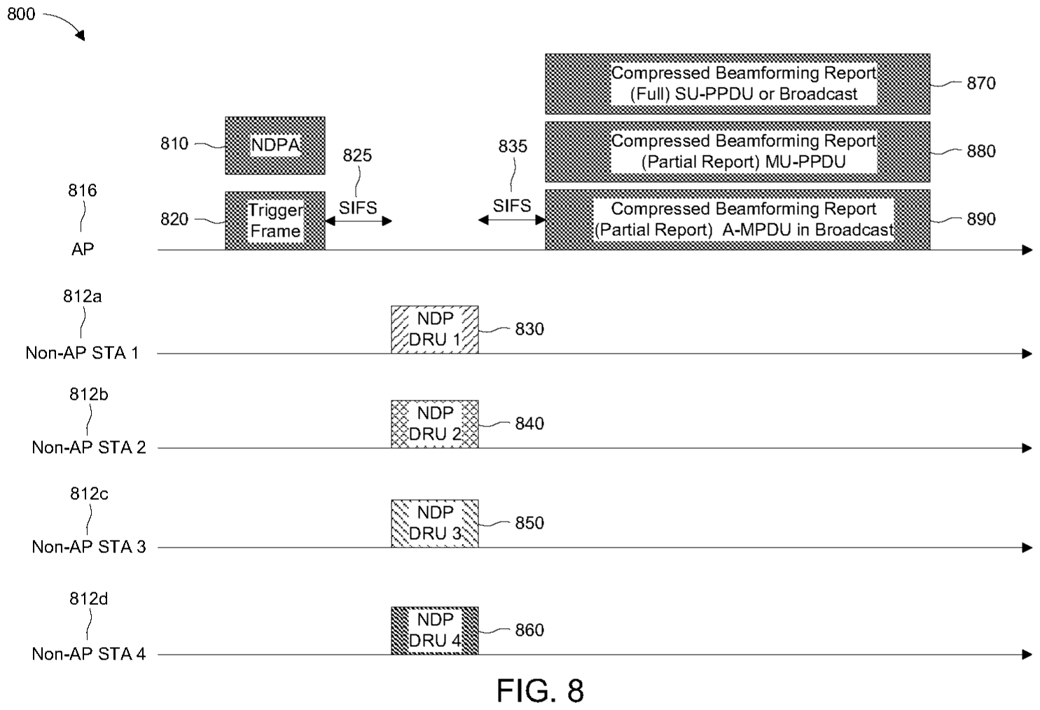

FIG. 8 is a transmission diagram illustrating an example of a general uplink sounding procedure for a DRU. As shown in an example in transmission diagram 800, an AP 816 may send a trigger frame 820 or an NDPA 810 soliciting an NDP where one or more UHR-LTFs 830 are sent by non-AP STA1 812a over the tones occupied by DRU1, the one or more UHR-LTFs 840 are sent by non-AP STA2 812b over the tones occupied by DRU2, one or more UHR-LTFs 850 are sent by non-AP STA3 812c over the tones occupied by DRU3, and one or more UHR-LTFs 860 are sent by non-AP STA4 812d over the tones occupied by DRU4. The received NDP at the AP 816 may then be used to measure the channel for each respective non-AP STA. In an example, the received NDP may include UHR-LFTs 830, 840, 850, 860. Further, AP 816 may receive the NDP after short-interframe space (SIFS) 825 and before SIFS 835.

Additionally or alternatively, the AP 816 may solicit the NDP transmission over the same DRU from different non-AP STAs by allocating a different spatial stream to each non-AP STA. In one example, the SS Allocation field of the User Info field in the Trigger frame may be used to allocate a Special Stream (SS) for each non-AP STA to transmit the DRU NDP. In an example, the User Info field in the trigger frame may be in the form provided in Table 8, further below.

In another example, the SS Allocation field of the STA Info field in the NDPA may be used to allocate a Special Stream (SS) for each non-AP STA to transmit the DRU NDP. In an example, the STA Info field in the NDPA may be in the form provided in Table 5, further below.

In an example, the AP may estimate the CSI or the channel quality indicator (CQI) for the entire NDP received from different non-AP STAs and send the feedback to the non-AP STAs by one, or a combination of, of the following example methods. In a first example method, the AP may send a single user (SU) PPDU including the feedback of all the subcarriers of the entire bandwidth of the NDP for all the non-AP STAs addressed in the trigger frame or the NDPA used to initiate the sounding procedure. Additionally or alternatively, the SU-PPDU may include a compressed beamforming report. Additionally or alternatively, the compressed beamforming report may be broadcast by the AP to the non-AP STAs.

In example method 2, the AP may send an MU PPDU where a resource is allocated to each of the non-AP STAs, that are addressed in the trigger frame or the NDPA used to initiate the sounding procedure, where each non-AP STA receives the feedback of the corresponding DRU this non-AP STA transmitted the NDP on. Additionally or alternatively, the MU-PPDU may include a compressed beamforming report.

In example method 3, the AP may send a broadcast packet including the feedback of the respective DRUs in an aggregate MAC Protocol Data Unit (A-MPDU), where each MPDU contains the feedback of the respective DRU of each of the non-AP STAs, addressed in the Trigger frame or the NDPA used to initiate the sounding procedure. Additionally or alternatively, the A-MPDU may include a compressed beamforming report. Additionally or alternatively, the compressed beamforming report in the A-MPDU may be broadcast by the AP to the non-AP STAs.

In an example, the distribution bandwidth of each DRU allocated to one of the non-AP STAs addressed in the trigger frame or the NDPA used to initiate the sounding procedure may be the same for all DRUs. In one example, DRU 1 830, DRU 2 840, DRU 3 850 and DRU 4 860 in FIG. 8 may all have the same distribution bandwidth of 80 MHz.

Additionally or alternatively, the distribution bandwidth of each DRU allocated to one of the non-AP STAs addressed in the Trigger frame or the NDPA used to initiate the sounding procedure may be different for a different DRU. In one example, in FIG. 8, DRU 1 830 may have a distribution bandwidth of 20 MHZ, DRU 2 840 may have a distribution bandwidth of 40 MHZ, and DRU 3 850 and DRU 4 860 may each have a distribution bandwidth of 80 MHz.

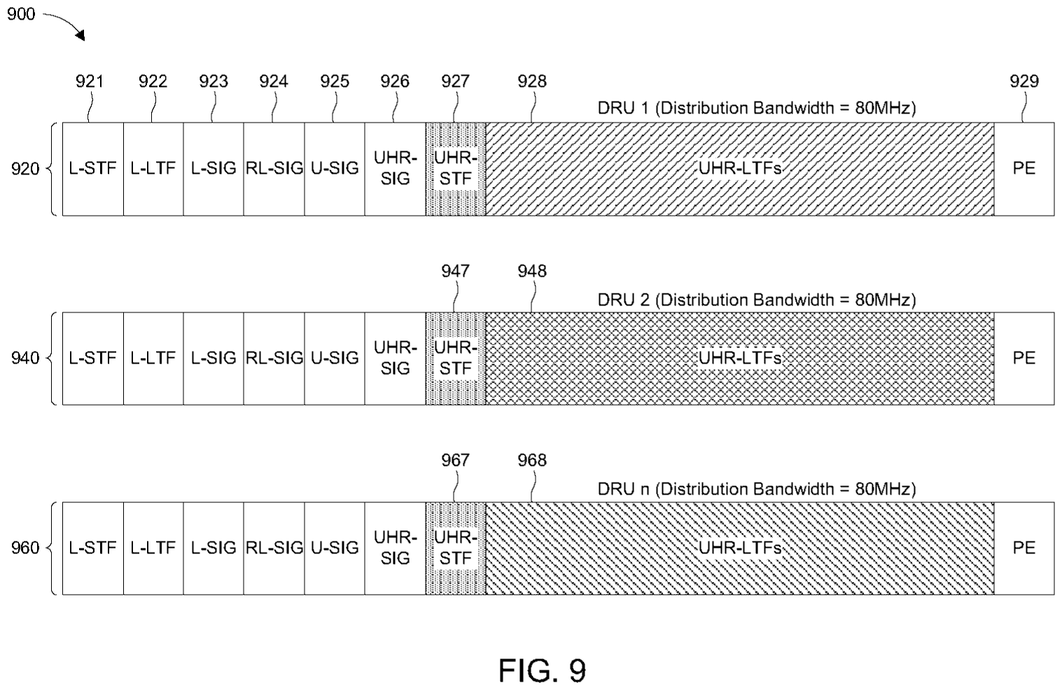

FIG. 9 is a transmission diagram illustrating an example of UHR sounding NDP formats for DRUs. An example shown in transmission diagram 900 provides a UHR Sounding NDP format, used by UHR Sounding NDP 920, UHR Sounding NDP 940 and UHR Sounding NDP 960. The UHR Sounding NDP format may include in the preamble legacy short training field (L-STF) 921, legacy LTF (L-LTF) 922, legacy signal (L-SIG) 923, universal signal (U-SIG) 925, UHR signal (UHR-SIG) 926, which are the same for all non-AP STAs participating in the sounding procedure. The respective UHR-LTFs 928, 948, 968 of NDPs 920, 940, 960 may be transmitted from each respective non-AP STA on a different respective DRU to an AP. In examples, one or more of the UHR-LTFs 928, 948, 968 may be 1×LTF, 2×LTF or 4×LTF. Further, the respective UHR-STFs 927, 947, 967 of NDPs 920, 940, 960 may be transmitted from each respective non-AP STA to the AP.

In a further example, the UHR-STF, such as UHR-STFs 927, 947, 967, of a TB-PPDU transmitted over the tones of a DRU may cover all of the STF tones of the distribution bandwidth of this DRU. The number of STF tones for any DRU size will depend on the distribution bandwidth of this DRU. Further, the density of the STF tones will remain the same regardless of the size of the DRU and regardless of the distribution bandwidth of the DRU. For example, any xDRU20 will have 31 STF tones or subcarriers with the subcarrier indices located at [−120:8:120]. The density of STF tones is 2/13 for all DRU sizes and distributions bandwidths, where 2 STF tones are transmitted out of 13 tones covering each one MHz of bandwidth. The UHR-STF tones may not get power boosted and may be differentiated by applying a global cyclic shift delay (CSD) to the STF transmitted by each STA.

In a another example, the UHR-LTF may specifically use the 4×LTF mode such that each DRU may have an equal number of data tones and pilot tones in the distributed LTF that are almost evenly distributed across the bandwidth of the NDP.

In an example, the UHR PHY Capabilities Information field, or any other capabilities information field, in the UHR Capabilities element, or any other UHR element that may announce capabilities, may be used to indicate that a STA supports one or more of DRU sounding, UL DRU sounding, or implicit DRU sounding. Additionally or alternatively, any other capability indication element in a UHR amendment or future amendment to standard wireless procedures may be used to indicate that a STA supports one or more of DRU sounding, UL DRU sounding, or implicit DRU sounding.

In an example, a UHR capabilities element format may contain fields as shown in Table 3 below.

TABLE 3
UHR Capabilities Element Format

| | | | | |
|---|---|---|---|---|
| Element | Length | Element | UHR | UHR |
| ID | | ID | MAC | PHY |
| | | Extension | Capabilities | Capabilities |
| | | | Information | Information |

Further, the UHR PHY capabilities information field of the UHR capabilities element format may include a field for the support of DRU sounding, as shown in an example in Table 4 below.

TABLE 4
UHR PHY Capabilities Information Field

Support
For
DRU
Sounding

As an example shown in Table 4 of a field for the support of DRU sounding, a field named Support For DRU Sounding may be defined such that setting this field to a value of 1 indicates that the STA supports the channel sounding operation on DRUs. Also, the setting of the field DRU Sounding to a value 0 indicates that the STA does not support the channel operation on DRUs.

Additionally or alternatively, sounding may be defined such that setting this field to a value of 0 indicates that the STA supports the channel sounding operation on DRUs; and the setting of the field DRU Sounding to a value 1 indicates that the STA does not support the channel operation on DRUs.

In an example, the STA Info field in the UHR NDP Announcement frame may be defined to enable uplink channel sounding on DRUs, as in example in Table 5, further below. A field named DRU Allocation Index may be defined in the STA Info field in the UHR NDP Announcement frame. The DRU Allocation Index field may carry an index that uniquely identifies a DRU for which the STA receiving this NDPA and identified by the AID11 in the STA Info field may be requested to send a UHR sounding NDP as defined in FIG. 9 where the LTF will be sent on the requested DRU.

In another example, the STA Info field in the UHR NDP Announcement frame may include a field named Distribution Bandwidth to signal the distribution bandwidth of the requested DRU for the uplink sounding procedure. An example of the encoding of the Distribution Bandwidth field is listed in Table 6, shown further below.

In an example, the DRU Allocation Index in combination with the Distribution Bandwidth may be used to uniquely identify a DRU for which the STA receiving this NDPA and identified by the AID11 in the STA Info field may be requested to send a UHR sounding NDP. In another example, the DRU Allocation Index may be used solely to uniquely identify a DRU for which the STA receiving this NDPA and identified by the AID11 in the STA Info field may be requested to send a UHR sounding NDP.

Further, in an example, in non-punctured a 80 MHz of frequency bandwidth, the distribution bandwidth of the DRUs may be either 80 MHZ, 20 MHZ+20 MHz+40 MHZ, or 40 MHz+20 MHz+20 MHz. If the distribution bandwidth is chosen to be 80 MHz, the DRU Allocation Index may refer to a unique DRU which may be an xDRU80 (a DRU with x tones distributed over a distribution bandwidth of 80 MHZ).

If the distribution bandwidth is chosen to be 20 MHz+20 MHz+40 MHZ, the DRU Allocation Index may refer to a unique DRU which may be an xDRU20 (a DRU with x tones distributed over a distribution bandwidth of 20 MHZ). Further, the DRU Indication Index can uniquely identify whether the 20 MHz is the first 20 MHz of the 80 MHz channel or the second 20 MHz of the 80 MHz channel.

Additionally or alternatively, if the distribution bandwidth is chosen to be 20 MHz+20 MHz+40 MHz, the DRU Allocation Index may refer to a unique DRU which may be an xDRU40 (a DRU with x tones distributed over a distribution bandwidth of 40 MHZ). Further, the DRU Indication Index can uniquely identify that the 40 MHz is the last 40 MHz of the 80 MHz channel.

If the distribution bandwidth is chosen to be 40 MHz+20 MHz+40 MHz, the DRU Allocation Index may refer to a unique DRU which may be an xDRU40 (a DRU with x tones distributed over a distribution bandwidth of 40 MHZ). Further, the DRU Indication Index can uniquely identify that the 40 MHz is the first 40 MHz of the 80 MHz channel.

Additionally or alternatively, if the distribution bandwidth is chosen to be 40 MHz+20 MHz+40 MHZ, the DRU Allocation Index may refer to a unique DRU which may be an xDRU20 (a DRU with x tones distributed over a distribution bandwidth of 20 MHZ). Further, the DRU Indication Index can uniquely identify whether the 20 MHz is the third 20 MHz of the 80 MHz channel or the fourth 20 MHz of the 80 MHz channel.

Additionally or alternatively, the AID11 field contains the 11 LSBs of the Associated STA Identifier (AID) of an associated STA or the Unassociated STA Identifier (USID) of an unassociated STA. Additionally or alternatively, the LTF Repetitions field indicates the number of LTF repetitions in the solicited UHR sounding NDP in the uplink from the non-AP STA identified in the AID11 field. The LTF Repetitions field is set to the number of LTF repetitions minus 1. The value of the LTF Repetitions field is the same in all STA Info fields in the NDPA for both DRU and RRU sounding.

Additionally or alternatively, the UL Target Receive Power subfield indicates the expected receive signal power, measured at the AP's antenna connector and averaged over the antennas, for the UHR portion of the UHR TB PPDU transmitted on the assigned DRU or RRU.

In another example, the NDPA may have an AP Tx Power subfield to indicate the transmit power of the PPDU that carries the NDPA (or the trigger frame). These power related information may be also carried in the trigger frame. The purpose of these subfields is to set the transmit power for symbols in the LTF field in NDPs to ensure the same or similar received power level for all received NDPs at the AP.

In an example, the UHR NDPA may be used to request uplink channel sounding for RRUs for some of the STAs identified in the NDPA. This mode of channel sounding may be called hybrid uplink sounding. In this case, the Distribution Bandwidth field is set to a value of 0 and the Partial Bandwidth field may be used to indicate which RRUs the STA is required to send the sounding NDP over, as shown in an example in Table 7, further below.

TABLE 5
STA Info field format in an UHR NDP Announcement
frame for Uplink DRU Channel Sounding

| | | | | | | | |
|---|---|---|---|---|---|---|---|
| AID11 | DRU | Distribution | LTF | AP Tx | SS | UL Target | Reserved |
| | Allocation | Bandwidth | Repetitions | Power | Allocation | Receive | |
| | Index | | | | | Power | |

TABLE 6
Encoding of the Distribution Bandwidth field

| Distribution | | |
|---|---|---|
| Bandwidth | Allocated | |
| field | Distribution | |
| Value | Bandwidth | |
| 0 | RRU (Regular RU) | |
| 1 | 20 | MHz |
| 2 | 40 | MHz |
| 3 | 80 | MHz |
| 4 | 160 | MHz |
| 5 | 320 | MHz |

TABLE 7
STA Info field format in an UHR NDP Announcement
frame for Uplink RRU Channel Sounding

| | | | | | | | |
|---|---|---|---|---|---|---|---|
| AID11 | Partial | Distribution | LTF | AP Tx | SS | UL Target | Reserved |
| | Bandwidth | Bandwidth | Repetitions | Power | Allocation | Receive | |
| | Info | | | | | Power | |

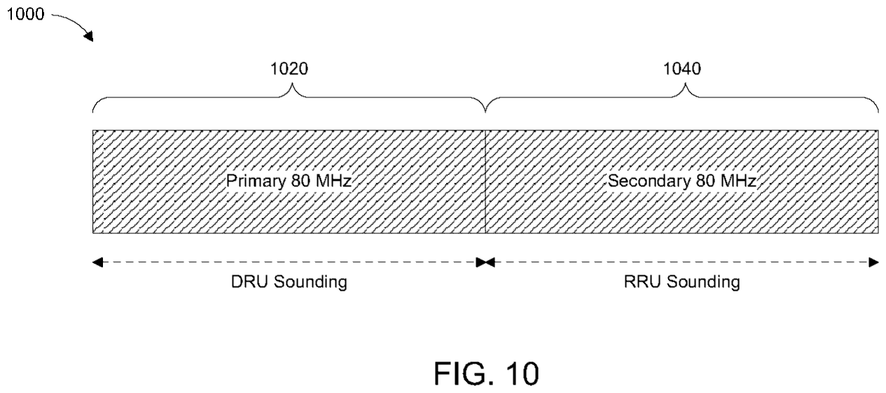

FIG. 10 is a channel diagram illustrating an example of a hybrid channel sounding example. As shown in an example in channel diagram 1000, a STA may be requested to send the sounding NDP on one or more DRUs 1020 in a STA Info field, and to send the sounding NDP on one or more RRUs 1040 in a different STA Info field. Both requests are identified by the same AID11 of this STA as illustrated in the example in FIG. 10 or each request is identified by a different AID11 for a different STA.

In another example, a Trigger frame may be used to solicit the NDP transmission on DRUs. The User Info field in the UHR Trigger frame may be defined to enable uplink channel sounding on DRUs, as shown in example in Table 10, below.

TABLE 8
User Info field format in an UHR Trigger
frame for Uplink DRU Channel Sounding

| | | | | | | |
|---|---|---|---|---|---|---|
| AID12 | DRU | Distribution | LTF | SS | UL Target | Reserved |
| | Allocation | Bandwidth | Repetitions | Allocation | Receive | |
| | Index | | | | Power | |

As shown in an example in Table 8, a field named DRU Allocation Index may be defined in the User Info field in the UHR Trigger frame. The DRU Allocation Index field may carry an index that uniquely identifies a DRU for which the STA receiving this Trigger frame and identified by the AID12 in the User Info field may be requested to send a UHR sounding NDP as defined in FIG. 9, where the LTF will be sent on the requested DRU.

In another example, the User Info field in the Trigger frame may include a field named Distribution Bandwidth to signal the distribution bandwidth of the requested DRU for the uplink sounding procedure. An example of the encoding of the Distribution Bandwidth field is listed in Table 6, further above.

In an example, the DRU Allocation Index in combination with the Distribution Bandwidth may be used to uniquely identify a DRU for which the STA receiving this Trigger frame and identified by the AID12 in the User Info field may be requested to send a UHR sounding NDP. In another example, the DRU Allocation Index may be used solely to uniquely identify a DRU for which the STA receiving this Trigger frame and identified by the AID12 in the STA Info field may be requested to send a UHR sounding NDP.

Additionally or alternatively, the AID12 field contains the 12 LSBs of the AID of an associated STA or the USID of an unassociated STA. Additionally or alternatively, the LTF Repetitions field indicates the number of LTF repetitions in the solicited UHR sounding NDP in the uplink from the non-AP STA identified in the AID12 field. The LTF Repetitions field is set to the number of LTF repetitions minus 1. The value of the LTF Repetitions field is the same in all User Info fields in the Trigger frame for both DRU and RRU sounding.

Additionally or alternatively, the UL Target Receive Power subfield indicates the expected receive signal power, measured at the AP's antenna connector and averaged over the antennas, for the UHR portion of the UHR TB PPDU transmitted on the assigned DRU or the assigned RRU.

In an example, the UHR Trigger frame may be used to request uplink channel sounding for RRUs for some of the STAs identified in the Trigger frame. This mode of channel sounding may be called hybrid uplink sounding. In this case, the Distribution Bandwidth field is set to a value of 0 and the DRU Allocation Index field may be used to indicate which RRUs the STA is required to send the sounding NDP over as indicate in an example shown in Table 8, above.

In an example, the STAs required to send the sounding NDP on DRUs may send the NDP on a part of the channel bandwidth 1020 that is different from the part of channel bandwidth that is used by the STAs required to send the NDP on RRUs 1040 as illustrated in FIG. 10.

In an example, the AP may receive the sounding NDP sent from different STAs interleaved using different DRUs and may measure the CSI and prepare the feedback report. The feedback report may be prepared using one of three example methods.

In an example method, the AP may prepare a full report covering the entire bandwidth of the sounding NDP. The AP may then send the full report in a SU-PPDU broadcasted to all the STAs involved in the sounding procedure. Each STA may then receive the CSI and select the feedback measured for the subcarriers corresponding to the DRU allocated to it in the sounding procedure. In this method, the STAs receive the full feedback report of all subcarriers in the bandwidth of the NDP and select only the subcarriers corresponding to one or more of the DRUs.

In another example method, the AP may prepare partial feedback reports each of which is corresponding to the subcarriers of one or more of the DRUs. The AP may then send the partial reports in a MU-PPDU addressed to all the STAs involved in the sounding procedure. Each STA may then receive the CSI of the DRU allocated to it in the sounding procedure. In this method, each STA receives only the feedback for one or more of the DRUs in the bandwidth of the NDP or one or more of the DRUs in a part of the bandwidth of the NDP in case of hybrid channel sounding.

In a further example method, the AP may prepare partial feedback reports each of which is corresponding to the subcarriers of one or more of the DRUs. The AP may then send the partial reports in a SU-PPDU carrying an A-MPDU addressed to all the STAs involved in the sounding procedure. Each STA may then receive the CSI of the DRU allocated to it in the sounding procedure. In this method, each STA receives only the feedback for one or more of the DRUs in the bandwidth of the NDP or one or more of the DRUs in a part of the bandwidth of the NDP in case of hybrid channel sounding.

In yet another method, in uplink sounding, the feedback may be sent by the AP using individual SU-PPDUs each is sent to one of the beamformers using a different DRU.

In an example, in hybrid uplink sounding, the AP may prepare the feedback of the allocated one or more DRUs and one or more RRUs for a given non-AP STA and send it aggregated in the same resource in a MU-PPDU and addressed to the non-AP STA. In another method, the feedback of the one or more DRUs and the feedback of the one or more RRUs may be sent separately each in a separate resource in a MU-PPDU.

In another example, in hybrid uplink sounding, the AP may prepare a full report covering the entire bandwidth of the sounding NDP including the DRU sounding bandwidth part 1020 and the RRU sounding bandwidth part 1040, as shown in an example in FIG. 10. The AP may then send the full report in a SU-PPDU broadcasted to all the STAs involved in the sounding procedure. Each STA may then receive the CSI and select the feedback measured for the subcarriers corresponding to the one or more DRUs or the one or more RRUs allocated to it in the sounding procedure. In this method, the STAs receive the full feedback report of all subcarriers in the bandwidth of the NDP and select only the subcarriers corresponding to one or more of the DRUs, RRUs, or both.

In an example, the AP may solicit the transmission of the DRU NDPs from the different non-AP STAs to measure the CSI of the different DRUs allocated to the respective non-AP STAs. The AP may then use the CSI measurements for downlink beamforming. This mode of DRU channel sounding may be called implicit DRU sounding. In this mode, the AP will not transmit the feedback to the non-AP STAs since it will be used in downlink beamforming.

In an example, the channel sounding of DRUs in the downlink may be initiated by the beamformer (the AP) by transmitting a null data packet announcement (NDPA) followed after a SIFS (or any other IFS) by an NDP. The beamformee(s), the non-AP STAs, may then receive the NDP and measure the CSI for the allocated DRU for each of them in the NDPA. The beamformer may then solicit the feedback from the beamformees by sending a BeamForming Report Poll (BFRP) trigger frame, and the beamformees may respond by sending the beamforming report to the beamformer.

In an example in Table 9, below, a STA Info field may include a field named DRU Allocation Index. The DRU Allocation Index field may carry an index that uniquely identifies a DRU for which the STA receiving this NDPA and identified by the AID11 in the STA Info field may be requested to measure the CSI for this specific DRU and send the beamforming feedback to the beamformer.

In an example, the AID11 field contains the 11 LSBs of the AID of an associated STA or the USID of an unassociated STA. The No Index field, Feedback Type and Ng field, Disambiguation field, and Codebook Size may all have the same definition as in the EHT NDPA.

TABLE 9
STA Info field format in an UHR NDP Announcement
frame for Downlink DRU Channel Sounding

| | | | | | | | |
|---|---|---|---|---|---|---|---|
| AID11 | DRU | Distribution | Nc | Feedback | Disambiguation | Codebook | Reserved |
| | Allocation | Bandwidth | Index | Type And | | Size | |
| | Index | | | Ng | | | |

In another example, the STA Info field in the NDP Announcement frame may include a field named Distribution Bandwidth to signal the distribution bandwidth of the requested DRU for the downlink sounding procedure. An example of the encoding of the Distribution Bandwidth field is listed in Table 6, further above.

In an example, the DRU Allocation Index in combination with the Distribution Bandwidth may be used to uniquely identify a DRU for which the STA receiving this NDPA and identified by the AID11 in the STA Info field may be requested to measure the CSI for this specific DRU and send the beamforming feedback to the beamformer. In another example, the DRU Allocation Index may be used solely to uniquely identify a DRU for which the STA receiving this NDPA and identified by the AID11 in the STA Info field may be requested to measure the CSI for this specific DRU and send the beamforming feedback to the beamformer.

In an example, the UHR NDPA may be used to request downlink channel sounding for RRUs for some of the STAs identified in the NDPA. This mode of channel sounding may be called hybrid downlink sounding. In this case, the Distribution Bandwidth field is set to a value of 0 and the Partial Bandwidth field may be used to indicate which RRUs the STA is required to send the feedback for, as shown in an example in Table 10, below.

TABLE 10
STA Info field format in an UHR NDP Announcement
frame for Uplink RRU Channel Sounding

| | | | | | | | |
|---|---|---|---|---|---|---|---|
| AID11 | Partial | Distribution | Nc | Feedback | Disambiguation | Codebook | Reserved |
| | Bandwidth | Bandwidth | Index | Type And | | Size | |
| | Info | | | Ng | | | |

In an example, in hybrid downlink sounding, the NDP may be sent covering the entire bandwidth as specified by the PPDU carrying the NDPA. The STAs requested to measure the CSI of DRUs and the STAs requested to measure the RRUs may measure overlapping parts of the sounding bandwidth. In another example, a STA may be requested to measure a DRU in a STA Info field and to measure an RRU in a different STA Info field both are identified by the same AID11 of this STA.

In an example, a non-trigger-based sounding sequence may be defined for DRU sounding which may be initiated by a beamformer with an individually addressed NDPA frame. In an example, the individually addressed NDPA frame may include exactly one STA Info field followed after an SIFS by an UHR sounding NDP.

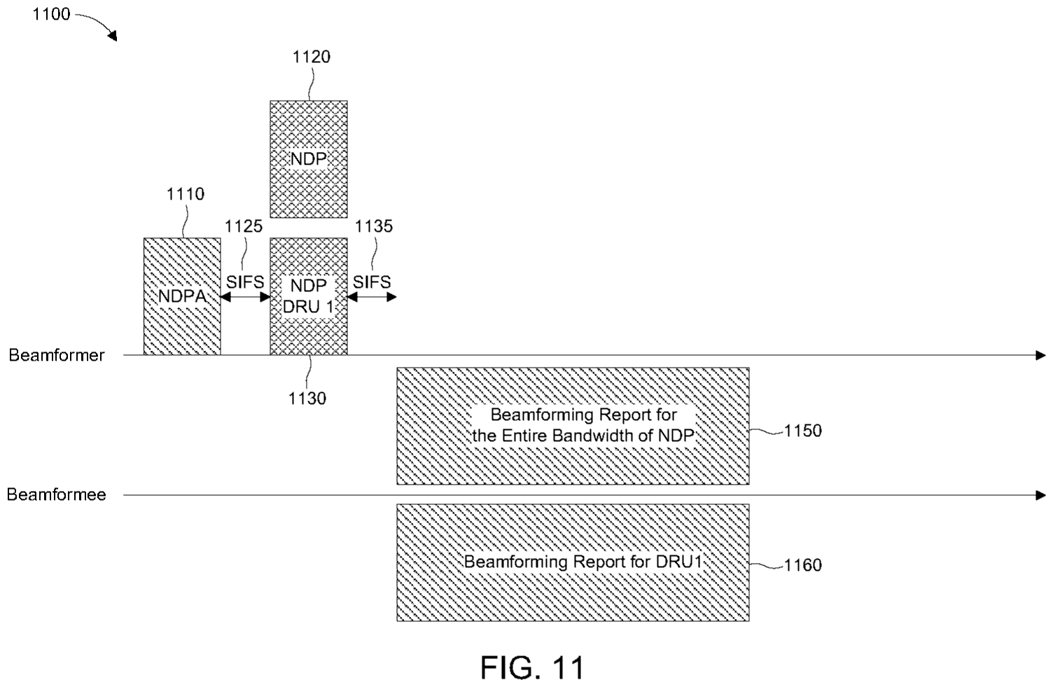

FIG. 11 is a signaling procedure diagram illustrating an example of non-trigger-based DRU sounding. As shown in signaling procedure diagram 1100, a beamformer may initiate DRU sounding with individually addressed NDPA frame 1110, which may include exactly one STA Info field followed, after an SIFS 1125, by a UHR sounding NDP. Then, the beamformee responds after an SIFS 1135 with a beamforming report.

In an example procedure, the sounding NDP 1120 may be sent over the entire bandwidth of the NDP as indicated by the PPDU carrying the NDPA 1110. In another example procedure, the sounding NDP 1130 may be sent only over the subcarriers of a certain DRU, such as DRU1. The NDP 1130 may sent as explained in an example shown in FIG. 9.

In an example, the beamformee may receive the sounding NDP sent from the beamformer and may measure the CSI and prepare the feedback report. The feedback report may be prepared using one or more example methods.

In one example method, the beamformee may measure all the subcarriers of the NDP in case the NDP is sent over the entire bandwidth, prepare the beamforming report accordingly, and send the report back to the beamformer 1150 after a SIFS 1135 from receiving the NDP. In another example method, the beamformee may measure the subcarriers of a certain DRU of the NDP in case the NDP is sent over the entire bandwidth, prepare the beamforming report accordingly, and send the report back to the beamformer after a SIFS 1135 from receiving the NDP. In yet another method, the beamformee may receive the NDP with the LTF sent only on the subcarriers corresponding to a certain DRU, such as DRU1, and prepare the beamforming report accordingly. The beamformee may send the beamforming report 1160 back to the beamformer after a SIFS 1135 from receiving the NDP.

In an example, the channel sounding of DRUs in punctured channels in the uplink may occur by indicating a different distribution bandwidth for the respective users that are assigned DRUs on the different subchannels that are not punctured. For example, a puncture channel may have multiple distribution bandwidths, such as two distribution bandwidths.

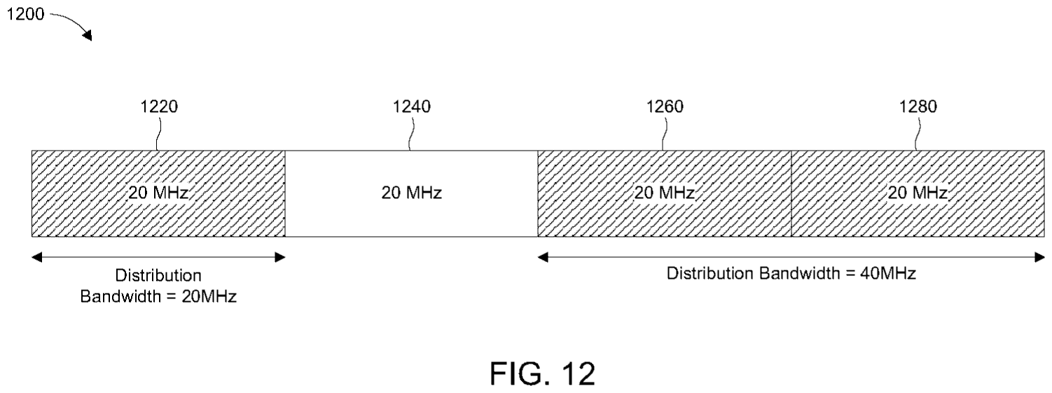

FIG. 12 is a channel diagram illustrating an example for a punctured 80 MHz with two different distribution bandwidths, the first is 20 MHz and the second is 40 MHZ. As shown in an example in channel diagram 1200, a punctured 80 MHz channel may have two distribution bandwidths, the first 20 MHz of the 80 MHz channel is the first distribution bandwidth 1220 and the last 40 MHz 1260, 1280 of the 80 MHz channel is the second distribution bandwidth. A 20 MHz portion 1240 of the 80 MHz channel may be punctured, in this example.

In an example, a STA solicited to transmit the NDP over a DRU of size xDRU20 (any DRU of size x tones) may transmit the NDP using the tones of the specific DRU assigned to it in the first 20 MHz 1220 of the 80 MHz channel. In another example, a STA solicited to transmit the NDP over a DRU of size xDRU40 (any DRU of size x tones) may transmit the NDP using the tones of the specific DRU assigned to it in the last 40 MHz 1260, 1280 of the 80 MHZ channel.

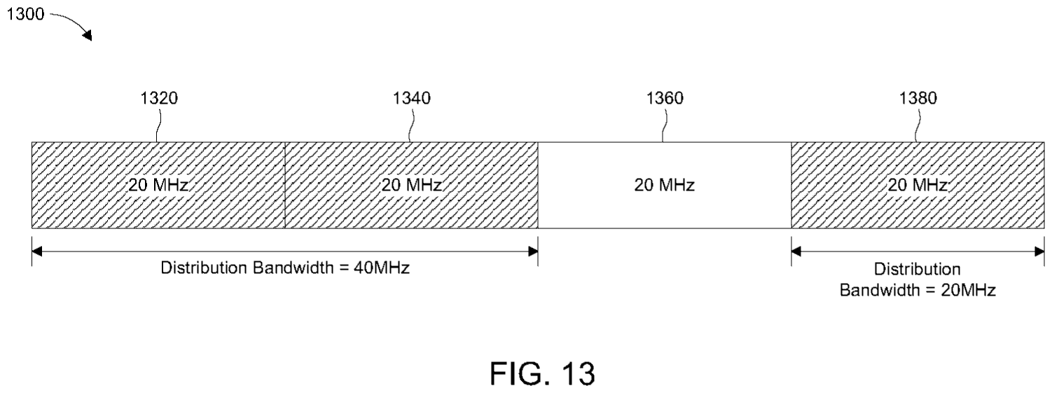

FIG. 13 is a channel diagram illustrating an example for a punctured 80 MHz with two different distribution bandwidths, the first is 40 MHz and the second is 20 MHz. As shown in an example in channel diagram 1300, a punctured 80 MHz channel may have two distribution bandwidths, the first 40 MHz 1320, 1340 of the 80 MHz channel is the first distribution bandwidth and the last 20 MHz 1380 of the 80 MHz channel is the second distribution bandwidth. A 20 MHz portion 1360 of the 80 MHz channel may be punctured, in this example.

In an example, a STA solicited to transmit the NDP over a DRU of size xDRU20 (any DRU of size x tones) may transmit the NDP using the tones of the specific DRU assigned to it in the last 20 MHz 1380 of the 80 MHz channel. In another example, a STA solicited to transmit the NDP over a DRU of size xDRU40 (any DRU of size x tones) may transmit the NDP using the tones of the specific DRU assigned to it in the first 40 MHz 1320, 1340 of the 80 MHz channel.

In an example, a STA may be solicited to transmit the NDP over the tones of two different DRUs each is on a different distribution bandwidth corresponding to the non-punctured sub-channels in a punctured channel. In one example, a STA may be solicited to transmit a 26DRU20 NDP and a 52DRU40 NDP at the same time. In this case, the STA may be identified by two STA Info fields (or two User Info fields) each identified by the same STA AID11 (or the STA AID 12) of the intended STA. In the first STA Info field (or User Info field), the assigned DRU may be a 26DRU20 and in the second STA Info field (or User Info field), the assigned DRU may be a 52DRU40. Considering the example in FIG. 12, the STA may transmit the 26DRU20 NDP on the first 20 MHz 1220 and may transmit the 52DRU40 on the last 40 MHz 1260, 1280.

In an example, a DRU distributed over a distribution bandwidth (e.g., distribution bandwidth=80 MHZ) may have a punctured subchannel in the distribution bandwidth (e.g., a punctured 20 MHz or a punctured 40 MHZ). In this mode of operation, the DRU is not distributed over the non-punctured portion of the channel as described in the previous section, rather, the DRU itself is punctured. In one example, a 52DRU80 distributed over an 80 MHz distribution bandwidth with a 20 MHz subchannel punctured will have one fourth of its subcarriers punctured (13 tones) leaving 39 tones unpunctured and distributed over the 80 MHZ. In another example, a 52DRU80 distributed over an 80 MHz distribution bandwidth with a 40 MHz subchannel punctured will have a half of its subcarriers punctured (26 tones) leaving 26 tones unpunctured and distributed over the 80 MHz.

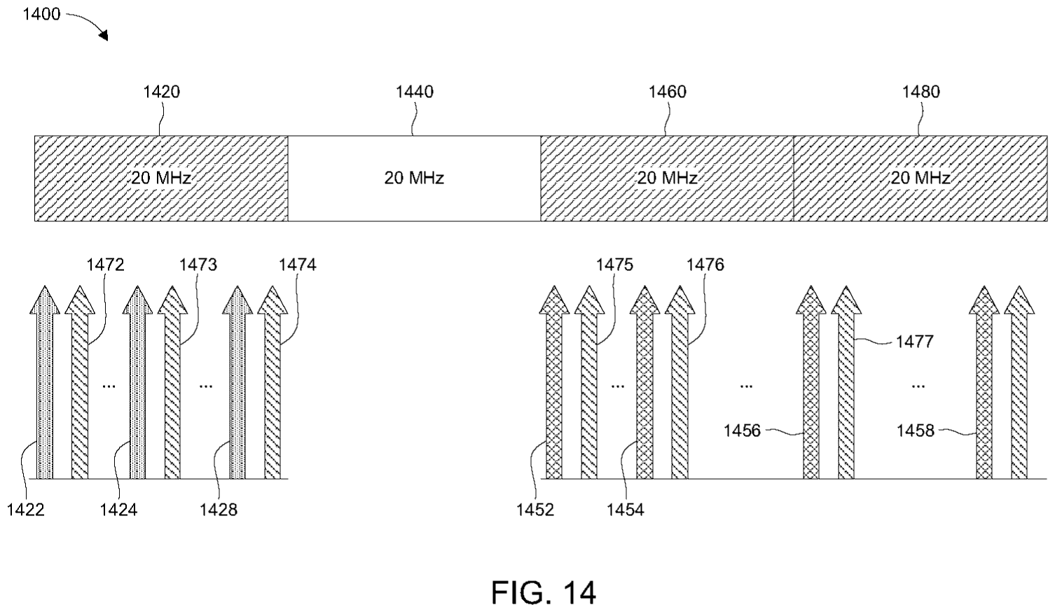

FIG. 14 is a channel signaling diagram illustrating an example of channel sounding of a punctured DRU distributed over an 80 MHz distribution bandwidth with a 20 MHz puncture. In an example shown in channel signaling diagram 1400, a STA 1 may be requested to transmit the NDP for uplink channel sounding on an xDRU20 (a DRU with x tones, where x may be 26, 52, or 106 tones) as indicate by arrows 1422, 1424, 1428. A STA 2 may be requested to transmit the NDP for uplink channel sounding on an xDRU40 (a DRU with x tones, where x may be 26, 52, or 106 tones) as indicate by arrows 1452, 1454, 1456, 1458. A STA 3 may be requested to transmit the NDP for uplink channel sounding on an xDRU80 (a punctured DRU with x tones, where x may be 26, 39, 52, or 78 tones) as indicate by the arrows 1472, 1473, 1475, 1477, 1458.

In an example, a STA may be requested to send the NDP on a DRU where the channel sounding takes place but is allocated a different DRU for transmission later. The tones of the allocated DRU may be next to the tones of the DRU where the channel sounding took place and hence, they may be correlated.

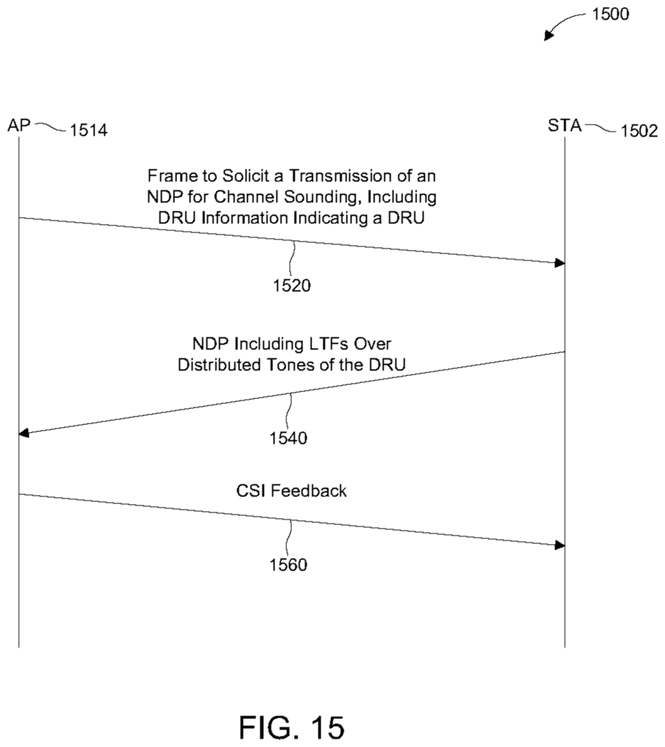

FIG. 15 is a signaling diagram illustrating an example of channeling sounding over distributed tones of a DRU. As shown in an example in signaling diagram 1500, an AP 1514 transmits, to a STA 1502, a frame 1520. The STA 1502 receives the frame 1520. Further, the frame 1520 includes DRU information indicating a DRU. Additionally or alternatively, the frame may be at least one of a control frame, management frame, or data frame. Additionally or alternatively, the control frame may be a trigger frame.

The STA 1502 transmits, to the AP 1514, the NDP 1540. The NDP includes, one or more LTFs which are transmitted over a plurality of distributed tones of the DRU 1540. Moreover, the DRU is indicated by the received DRU information. The AP 1514 receive the NDP. In this way, the channel sounding may be performed in a Wi-Fi system.

Additionally or alternatively, the DRU information indicating the DRU may include a DRU allocation index field, or both a DRU allocation index field and a distribution bandwidth field. Additionally or alternatively, the distribution bandwidth field may include a distribution bandwidth field value and an allocated distribution bandwidth, and each value of the distribution bandwidth field value corresponds to a respective distribution bandwidth of the allocated distribution bandwidth.

Additionally or alternatively, the STA 1502 may receive, from the AP 1514, CSI feedback responsive 1560 to the transmitted NDP. Additionally or alternatively, the STA 1502 may transmit, to the AP 1514 during an association or re-association, a DRU sounding support indication within a capabilities information field.

Additionally or alternatively, the control frame may include an NDPA frame including a STA info field, the STA info field indicating a STA AID field, and indicating a DRU allocation index field, or both a DRU allocation index field and a distribution bandwidth field. Additionally or alternatively, the control frame includes a first STA info field for DRU sounding on a first subchannel based on a first DRU allocation index field and a first distribution bandwidth field, and control frame further includes a second STA info field for RRU sounding on a second subchannel. Additionally or alternatively, the first and the second STA info fields may have different AIDs, and wherein the second STA info field is for another STA for DRU sounding on a second subchannel based on a second DRU allocation index field and a second distribution bandwidth field. Additionally or alternatively, the first and the second STA info fields may have a same AID.

Additionally or alternatively, the first subchannel is a primary subchannel. Additionally or alternatively, the second subchannel is a secondary subchannel non-overlapping with the first subchannel.

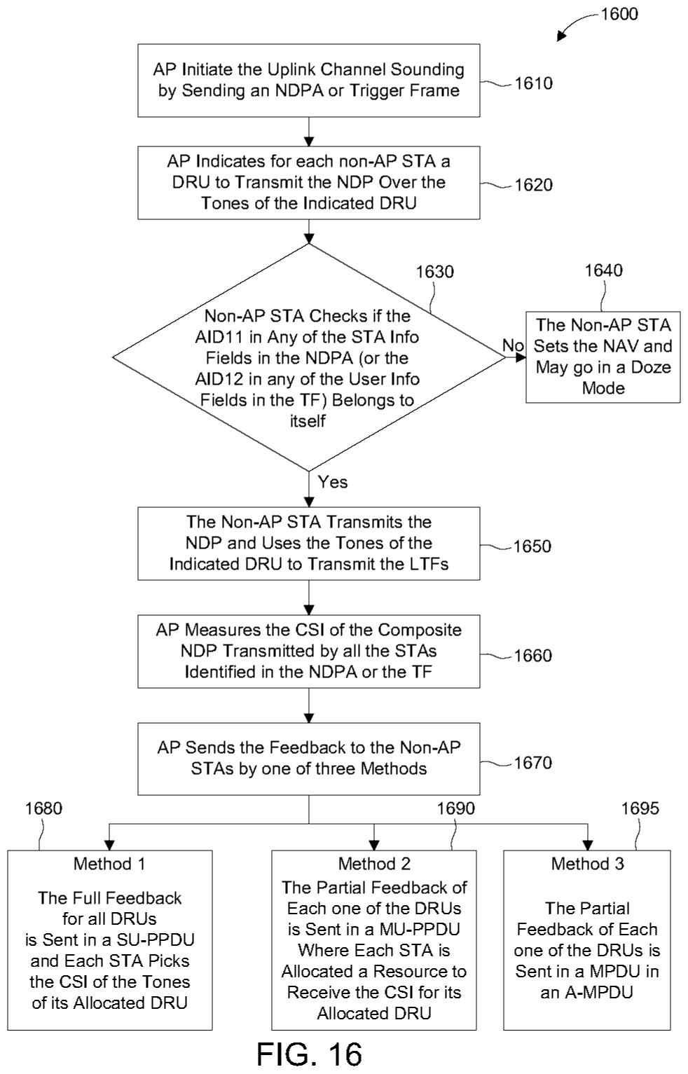

FIG. 16 is a flowchart diagram illustrating an example of behavior of STAs for uplink DRU channel sounding. As shown in an example in flowchart diagram 1600, an uplink channel sounding procedure is initiated by the AP STA by sending the NDPA (or trigger frame) to the STAs 1610 identified in the STA Info list of the NDPA (or the User Info list of the Trigger frame). In each STA Info field (or User Info field), the AP indicates 1620 for each non-AP STA a DRU to transmit the NDP over the tones of the indicated DRU.

Further, the non-AP STA checks if the AID11 in any of the STA Info fields in the NDPA (or the AID12 in any of the User Info fields in the TF) belongs to itself 1630. If the non-AP STA does not find its own AID in the list, the non-AP STA sets the NAV and may go in a doze mode 1640. Otherwise, the non-AP STA transmits the NDP and uses the tones of the indicated DRU to transmit the LTFs 1650. The AP measures the CSI of the composite NDP transmitted by all the STAs identified in the NDPA or the TF 1660.

Moreover, the AP then sends the feedback to the non-AP STAs by one of three methods 1670. In method 1, the full feedback for all DRUs is sent in a SU-PPDU and each STA picks the CSI of the tones of its allocated DRU 1680. In method 2, the partial feedback of each one of the DRUs is sent in a MU-PPDU where each STA is allocated a resource to receive the CSI for its allocated DRU 1690. In method 3, the partial feedback of each one of the DRUs is sent in a MPDU in an A-MPDU 1695.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A station (STA) comprising:
a transceiver; and
a processor, operatively coupled to the transceiver; wherein:
the transceiver and the processor are configured to receive, from an access point (AP), a frame to solicit transmission of a null data packet (NDP) for channel sounding, the frame including distributed resource unit (DRU) information indicating a DRU; and
the transceiver and the processor are configured to transmit, to the AP, the NDP, wherein one or more long training fields (LTFs) of the NDP are transmitted over a plurality of distributed tones of the DRU, wherein the DRU is indicated by the received DRU information.

2. The STA of claim 1, wherein the frame is at least one of a control frame, a management frame, or a data frame.

3. The STA of claim 2, wherein the control frame includes an NDP announcement (NDPA) frame including a STA info field, the STA info field indicating a STA association identifier (AID) field, and indicating a DRU allocation index field, or both a DRU allocation index field and a distribution bandwidth field.

4. The STA of claim 3, wherein the control frame includes a first STA info field for DRU sounding on a first subchannel based on a first DRU allocation index field and a first distribution bandwidth field, and wherein the control frame further includes a second STA info field for regular resource unit (RRU) sounding on a second subchannel.

5. The STA of claim 4, wherein the first STA info field and the second STA info field have different AIDs, and wherein the second STA info field is for another STA for DRU sounding on a second subchannel based on a second DRU allocation index field and a second distribution bandwidth field.

6. The STA of claim 4, wherein the first STA info field and the second STA info field have a same AID.

7. The STA of claim 1, wherein the DRU information indicating the DRU includes a DRU allocation index field, or both a DRU allocation index field and a distribution bandwidth field.

8. The STA of claim 7, wherein the distribution bandwidth field includes a distribution bandwidth field value and an allocated distribution bandwidth, wherein each value of the distribution bandwidth field value corresponds to a respective distribution bandwidth of the allocated distribution bandwidth.

9. The STA of claim 1, wherein the receiver and the processor are further configured to receive, from the AP, channel state information (CSI) feedback responsive to the transmitted NDP.

10. The STA of claim 1, wherein the transmitter and the processor are further configured to transmit, to the AP during an association or re-association, a DRU sounding support indication within a capabilities information field.

11. A method for use in a station (STA), the method comprising:
receiving, from an access point (AP), a frame to solicit transmission of a null data packet (NDP) for channel sounding, the frame including distributed resource unit (DRU) information indicating a DRU; and
transmitting, to the AP, the NDP, wherein one or more long training fields (LTFs) of the NDP are transmitted over a plurality of distributed tones of the DRU, wherein the DRU is indicated by the received DRU information.

12. The method of claim 11, wherein the frame is at least one of a control frame, a management frame, or a data frame.

13. The method of claim 12, wherein the control frame includes an NDP announcement (NDPA) frame including a STA info field, the STA info field indicating a STA association identifier (AID) field, and indicating a DRU allocation index field, or both a DRU allocation index field and a distribution bandwidth field.

14. The method of claim 13, wherein the control frame includes a first STA info field for DRU sounding on a first subchannel based on a first DRU allocation index field and a first distribution bandwidth field, and wherein the control frame further includes a second STA info field for regular resource unit (RRU) sounding on a second subchannel.

15. The method of claim 14, wherein the first STA info field and the second STA info field have different AIDs, and wherein the second STA info field is for another STA for DRU sounding on a second subchannel based on a second DRU allocation index field and a second distribution bandwidth field.

16. The method of claim 14, wherein the first STA info field and the second STA info field have a same AID.

17. The method of claim 11, wherein the DRU information indicating the DRU includes a DRU allocation index field, or both a DRU allocation index field and a distribution bandwidth field.

18. The method of claim 17, the distribution bandwidth field includes a distribution bandwidth field value and an allocated distribution bandwidth, wherein each value of the distribution bandwidth field value corresponds to a respective distribution bandwidth of the allocated distribution bandwidth.

19. The method of claim 11, further comprising:
receiving, from the AP, channel state information (CSI) feedback responsive to the transmitted NDP.

20. The method of claim 11, further comprising:
transmitting, to the AP during an association or re-association, a DRU sounding support indication within a capabilities information field.
